(19) United States
(12) Patent Application Publication
(10) Pub. No.: US 2002/0194099 A1
(43) Pub. Date: Dec. 19, 2002

(54) Proxy asset system and method

(76) Inventor: Allan N. Weiss, Cambridge, MA (US)

Correspondence Address: David M. Mello, McDermott, Will & Emery, 28 State Street, Boston, MA, 02109, US

(21) Appl. No.: 10/087,339

(22) Filed: Mar. 1, 2002

Related U.S. Application Data
(63) Continuation-in-part of application No. 09/567,901, filed on May 10, 2000.
Application No. 09/567,901 is a continuation-in-part of application No. 09/408,103, filed on Sep. 29, 1999.
Application No. 09/408,103 is a continuation-in-part of application No. 08/961,121, filed on Oct. 30, 1997, now Pat. No. 5,987,435.
(60) Provisional application No. 60/272,625, filed on Mar. 1, 2001.

(51) Int. Cl. G06F 17/60

(52) U.S. Cl. 705/36

(57) ABSTRACT

A new form of security designated the proxy asset provides risk management capabilities, such as liquid interests in illiquid assets and economic indicators, without the deficiencies associated with other types of financial instruments. A proxy assets set is defined to respond to one or more indices. Each proxy asset has a share value and a number of shares. The proxy assets have a proxy assets set account value equal to a sum over all proxy assets of the products of the share value and the number of shares. At least one proxy asset account value per share is a function of an index. The function is called an account formula. The account value for the entire set of proxy assets is constrained by a value of a resources pool. The proxy asset account value is reevaluated according to the account formula upon occurrence of each event of a plurality of predetermined events.

### CROSS REFERENCE TO RELATED APPLICATION

This application claims benefit of priority from U.S. Provisional Patent Application Serial No. 60/272,625, entitled PROXY ASSET SYSTEM AND METHOD filed Mar. 1, 2001, and is also a continuation-in-part of U.S. patent application Ser. No. 09/567,901 entitled TECHNIQUES FOR INVESTING IN PROXY ASSETS filed May 5, 2000, which is a continuation-in-part of U.S. patent application Ser. No. 09/408,103 entitled PROXY ASSET DATA PROCESSOR filed Sep. 29, 1999, which is a continuation of U.S. patent application Ser. No. 08/961,121 entitled PROXY ASSET DATA PROCESSOR filed Oct. 30, 1997, which issued as U.S. Pat. No. 5,987,435 on Nov. 16, 1999.

### BACKGROUND

1. Field of Invention

The present invention generally relates to techniques for managing a novel proxy asset investment vehicle and the institutions necessary to implement the proxy assets. More particularly, the present invention defines the proxy assets set, distributes, manages, and maintains a plurality of proxy assets shares, linked to account activity in accordance with pre-determined criteria. Some embodiments also execute trade, issuance and redemption of such proxy assets.

2. Description of Related Art

Investors take positions in many kinds of investments ranging from real estate, stocks, stock portfolios, equity interests in particular market players and broad markets, among others. As those of ordinary skill in the art of investing know, a long position with respect to a particular asset increases in value as the asset increases in value, while a short position increases in value as the asset decreases in value. Principles of risk management dictate that some of these investments be hedged by offsetting investments. Yet, offsetting investments with the proper response are often unavailable. In addition, some investments are in illiquid assets which are hard to sell or trade on short notice, and which usually impose the burdens of property management in order to assume a long position.

Making otherwise illiquid assets liquid is extremely important. With illiquid markets, investors may be stuck with an inordinately risky exposure to some illiquid assets and at the same time unable to diversify their portfolio. For example, in the market for single family homes, people may be excessively exposed to single family home price risk in their own city, unable to hedge this risk by shorting their city, and unable to invest in single family homes in other cities.

Laws and regulations regarding securities trading are designed to make a clear distinction between securities and derivatives (such as futures and options), and between securities and short sales. Institutions that hold securities as part of their portfolios may be restricted by charter, pronouncement or regulation from dealing freely in derivatives or from making short sales. These restrictions are designed to guarantee against certain abuses, such as taking excessively speculative positions. Individual investors, fearful of getting into an unexpectedly leveraged position or of exposure to large or unlimited losses in certain circumstances, such as margin calls, may have simple personal rules of thumb so that they will not buy unusual investment instruments.

Over time, there have been many different types of investment vehicles. Investment trusts (REITs), which were designed by an act of the U.S. Congress in 1960 to allow large numbers of investors in real estate, are no more than tax-exempt portfolios of existing readily-made real estate investments. The real estate that they cover is limited to already readily investable classes, excluding for example owner-occupied homes. REITs are not flexible and thus cannot meet current hedging and investment needs.

There are a number of mortgage, reverse mortgage, or sale-of-remainder methods that individual homeowners can use to reduce risk to them due to price fluctuations in their home. Shared appreciation mortgages have a long (though limited) history. A variation on this is the housing limited partnership. Reverse mortgages are contracts in which a homeowner is able to obtain a lifetime annuity from the value of his or her home. These reverse mortgages may pass some of the price risk to the mortgage lender. Sale of remainder refers to a contract in which the homeowner may sell a share in the house to another party with a contract to remain living in the house.

Home equity insurance, discussed in Robert J. Shiller and Allan N. Weiss, “Home Equity Insurance,” National Bureau of Economic Research Working Paper 1994, forthcoming, Journal of Real Estate Finance and Economics is an insurance contract on an individual home that pays out if the price index for the region should fall sufficiently.

In 1994, Barclays de Zoete Wedd (BZW) started Property Index Certificates (PICs). These are bonds, with maturities of two, three, four, and five years, whose principal at maturity is tied to a commercial real estate price index. BZW owns companies like Canary Wharf and Imry as a result of bad property loans, and has issued the PICs as a way to insulate itself from further moves in commercial real estate prices. In November 1996, BZW also created what are essentially UK commercial real estate index settled futures, although there is no clearing house and BZW is always one side of the contract. An industry-wide group led by AMP Asset Management (the fund management component of Australia Mutual Provident), has been scheduled to start true index-settled UK commercial real estate futures markets in 1997.

There have been for some time ordinary puts and calls that are settled on indices, such as the Standard and Poor's Index Options. There have been certain swap arrangements that investment banks make between themselves and counter parties. Banks may make many such swap arrangements in such a way that the swaps cancel out, and the bank itself bears no risk.

Index participations (IP) created at the American Stock Exchange (AMEX) in 1989 actually traded there for a few months before the contract was shut down due to regulatory difficulties. (A similar instrument was also created at the Philadelphia Stock Exchange the same year.) The IP were designed to create an alternative to stock index futures that could be traded on a stock exchange rather than a futures exchange. The investors in the long position received a regular dividend proportional to the dividend paid by the Standard and Poor Composite Stock Price Index. In this sense, the IP investors in the long positions could be considered effectively to be holding the stocks in the index itself. The investors in the short position put up 150% margin, and promised to pay the dividend to the investors in the long position. The shorts were subject to the usual margin calls should the price fall, and were not in any sense holding a security. The contracts involved no actual ownership of stocks; the dividends the investors in the long position received came from the investors in the short positions, rather than from the companies in the S&P 500. The investors in the short positions faced unlimited losses if they continued to meet margin calls. Moreover, there was a cash-out option. The investors in the long positions could at any time demand delivery from the holders of the short positions of the index value. The IPs did not allow the price of the IPs to differ from the S&P Index; they did not seek any price discovery by letting a market determine a price for shares in the IP.

The Standard and Poor Depositary Receipts (SPDRs, or, commonly, spiders) were created at the American Stock Exchange in 1993. Each SPDR is like a security, which is traded on the stock exchange, and behind it is an underlying basket of assets, representing the stocks used to compute the Standard and Poor Composite stock price average. Redemption and issuance rules enforce market price correspondence with the market price of the underlying portfolio. The assets held are the actual stocks themselves. Still, the SPDRs are used to create an asset that is like a stock and to insure that the market price corresponds at all times to the value of the basket of stocks. The “superunits” and the “supershares” created at the AMEX somewhat earlier also shared this property.

Certain computerized trading systems, such as that used at the Iowa Experimental Markets at the University of Iowa have been used in the past. For example, in their presidential election trading system, a security is created for every presidential candidate, and it pays $1 if that person is elected president. Since only one person can be elected president, the trading system can automatically create new securities whenever buy orders for all presidential candidates come in with combined offer prices equal to $1.

See also, “A Goal-Directed Financial Asset Management System” invented by Robert R. Champion and Basil R. Twist Jr., awarded U.S. Pat. No. 5,126,936 on Jun. 30, 1992, and a System for the Operation of a Financial Account invented by Charles A. Atkins and Amelia Island, and awarded U.S. Pat. No. 4,953,085 on Aug. 28, 1990.

In spite of the variety of investment instruments, investments having a particular response are often unavailable. Accordingly, none of the prior art allows hedging the risk of an arbitrary investment. What is needed is an investment instrument that can be constructed to allow an investor to hedge any reasonable economic position the investor may assume, but that also will allow a market to set a price.

### SUMMARY OF THE INVENTION

A proxy asset according to the present invention is a new kind of security that is designed to make effectively tradable broad categories of assets or claims on income flows, or economic indicators that are individually difficult or impossible to buy, hold, or sell directly. The proxy asset is designed to have a traded market price that reflects the true liquid-market value of the assets or claims or economic indicator. For example, proxy assets can be created that allow people to make investments in local real estate in a given city, but also allow owners of local real estate to hedge their exposure to real estate risk in that city. The proxy asset must also allow the purchasers to see, in the proxy asset share price, an indicator of real estate prices in the city. For another example, proxy assets can be created to allow people to invest in claims today on shares of the flow of national income over future years of some country or to allow people to hedge their own income risk, and also to see a market price of such a claim as never before. Thus, as used herein, the term proxy asset pertains to investments related to indexes, such as measures of assets and claims on income sources and economic indicators. Such measures of assets and claims on income sources include those related to human labor or human capital. Examples of illiquid assets that may be the basis of proxy assets include privately held or infrequently traded corporate stocks, infrequently traded bonds, ships and aircraft, rare coins, precious gemstones, masterpiece paintings, livestock, and thoroughbreds. These assets, like real estate, are highly illiquid, and are difficult or impossible to hedge using traditional hedging mechanisms. In most circumstances, an index is appropriate for a set of proxy assets if its value is not controlled or affected by those investing in that set of proxy assets.

An advantage of the proxy asset for the investment provider is that the payout and redemption value for a set of proxy assets defined together is fully funded by a resources pool under the control of the investment provider. Thus even small organizations can effectively define, offer and manage proxy assets. This is one way that proxy assets differ from derivatives offered by large investment houses.

A proxy asset data processor is employed as part of a proxy asset management system in one embodiment, and is designed for creating, distributing, managing, and maintaining the proxy assets. The new data processor defines and manages the value of accounts for these proxy assets, guaranteeing payment of a defined distribution by management of underlying cash-value accounts, and also facilitating trade, issuance and redemption of such proxy assets. These attributes thereby assure certain adding-up constraints for account values.

The proxy assets are configured to simplify their use and understanding by investors, to parallel familiar existing assets in appearance and in terms of the kinds of contingencies and activities that the investors become involved with, and to offer the same feeling of financial soundness. The proxy asset data processor is designed to reinforce and confirm these impressions among investors, by facilitating the basic functions necessary for the proxy asset's essential equivalence with other assets.

Proxy assets are designed to resemble existing well-known types of securities, like ordinary stocks, so that regulatory restrictions may have their intended effect. Thus, in embodiments of this invention, proxy asset shares are purchased outright and no position is leveraged or subject to a margin call. That proxy assets resemble familiar securities may also have certain psychological benefits. First, people are somewhat afraid of investing in exotic derivatives because they have the feeling that the structure of the contract is too complicated and abstract, unlike the common law concept of property that has been fundamental to human society since prehistoric times. People tend to feel insecure about an investment whose payoff is determined by a complex contract or mathematical formula in contrast to a traded market price. Second, there are familiar institutions and practices associated with ownership of securities that are not duplicated with most derivatives. Examples of such institutions and practices are the simple notion that an asset has both an enduring capital value and also generates an income over time, and that some investors may consume the income but not the capital value itself. Third, many derivatives can involve margin calls to which investors can react very negatively because such margin calls force investors to focus on their losses from individual portions of their portfolio, even when their overall portfolio is doing well. For example, investors who hedge against losses in holdings of an asset by taking a short position in the futures markets can be very upset by the repeated margin calls that would be the consequence of such hedging should prices increase. Investors tend to feel upset by margin calls, even though their losses in the futures market are compensated (since the value of the portfolio of other assets is increasing). The reason for this is that the margin call is made more psychologically salient by the need to take action. An individual who hedges risk by taking a position in a proxy asset whose price moves opposite that of the asset hedged will not be confronted by margin calls, can just forget about the portfolio, and thus may be psychologically in a frame of mind that better promotes hedging.

It is, therefore, an object of the present invention to provide techniques for creating, distributing, and managing proxy assets.

It is another object of the present invention to provide a data processing system that operates to define distributions to their holders based on the proxy assets in accordance with stored programmed criteria. The defined criteria characterize the proxy asset's value so that changes in a proxy asset's market price will approximately reflect the expected change in the value of the intended underlying index.

Investors become holders of claims (herein termed “shares”) in one or more proxy assets that have an underlying value by virtue of the proxy assets' linkage to a resources pool. The proxy asset account balance is adjusted over time in accord with changes in the value of the associated index and the pooled resources balances managed by an investment manager or bank. The system uses indices of the asset value or of income or economic indicators at set intervals or events, and employs these indices as a vehicle for determining the balances in the accounts, which in turn will affect the price and payouts (herein termed “dividends”) on the proxy asset. The database includes detailed account information and stores the updated account balances at set times or events as controlled by the processing logic. In preferred embodiments, upon the occurrence of set events, the system adjusts the account balances corresponding to each investor in each proxy asset by transfers between accounts in accordance with a formula associated with each proxy asset. The new balance controls the scale of the dividend or distribution paid on the proxy asset, rewarding through time those proxy assets tied to formulas that increase as determined by the indices. The proxy assets are exchanged in a market either via conventional brokerage services or directly through a trading system defined here, allowing a broad spectrum of investors access to this investment and risk management vehicle.

In accordance with some embodiments of the present invention, the proxy asset system further includes processing logic to permit selective bundling of proxy assets into proxy asset portfolios or proxy asset bundles. These proxy asset bundles are configured to permit enhanced distribution in response to changing investment and hedging demands for the underlying indices. Account features include the subsequent dispersion of the pools into their individual proxy assets. Accounts are linked to traditional markets to permit trading and exchanging of proxy assets by means akin to those techniques now employed to trade stocks and bonds.

According to one aspect of the invention, techniques provide a proxy asset set of two or more proxy assets that respond to a set of one or more indices. Each proxy asset of the proxy assets set has a proxy asset account value and a number of proxy asset shares representing equal claims on the proxy asset account value. The proxy assets set has a total number of shares equal to a sum over the proxy assets set of the number of proxy asset shares, and has a proxy assets set account value equal to a sum over the proxy assets set of the proxy asset account value. A proxy asset account value is defined with a predetermined account formula responsive to at least one corresponding index of the set of one or more indices. The proxy assets set account value is constrained by a value of a resources pool. The proxy asset account value is reevaluated according to the account formula upon occurrence of each event of a plurality of predetermined events.

In another aspect of the invention, techniques for investing in a proxy asset include maintaining a database having information indicative of a value for a resources pool, and information indicative of a particular investor account. The investor account information includes a particular investor of a set of investors, a particular proxy asset of the proxy assets set, and an investor account number of proxy asset shares. A signal indicative of the value of the resources pool is sent over a communications link. A proxy asset account value per share responsive to an index of the set of one or more indices is received over the communications link for each proxy asset of the proxy assets set.

In another aspect of the invention, techniques are provided for trading on an exchange shares of a proxy assets set of two or more proxy assets that respond to a set of one or more indices. Each proxy asset of the proxy assets set has a proxy asset account value and a number of proxy asset shares. A sum over the proxy asset set of the proxy asset account value substantially equals a value of a resources pool. A complete set of shares of the proxy assets set among one or more offers to trade shares of the proxy assets set is presented to a trader. A complete set satisfies a certain condition among shares of the proxy assets set.

In another aspect of the invention, techniques are provided for managing a proxy asset set of two or more proxy assets that respond to a set of one or more indices. A value of a resources pool and a value of an index of the set of indices are received. A proxy asset account value is evaluated according to an account formula responsive to the value of the index and a constraint. The constraint is on the proxy assets set account value imposed by the value of a resources pool. The evaluation is performed upon occurrence of each event of a plurality of predetermined events.

In another aspect of the invention, a system provides a proxy asset set of two or more proxy assets that respond to a set of one or more indices. A network is connected to a computer readable medium. The computer readable medium includes a value of a resources pool and a number of shares of each proxy asset for each investor of a set of investors. One or more bank processors connected to the network are configured to compute the value of the resources pool. One or more proxy assets set processors are configured to evaluate a proxy asset account value as a function of at least one corresponding index of the set of one or more indices. The one or more proxy assets set processors are also configured for constraining the proxy assets set account value by the value of the resources pool.

### BRIEF DESCRIPTION OF THE DRAWINGS

The foregoing and other objects of this invention, the various features thereof, as well as the invention itself, may be more fully understood from the following description, when read together with the accompanying drawings, described:

FIG. 1 is a block diagram illustrating examples of closed paths the data processor of the present invention may identify;

FIG. 2 is a relational block diagram depicting the proxy asset account manager;

FIG. 3A is a block diagram of the computer hardware available to practice the invention;

FIG. 3B is a block diagram of a computer system including a network;

FIG. 4 provides a logic flow diagram for a proxy asset generator, according to one embodiment of the present invention;

FIG. 5 provides a logic flow diagram for an account manager, according to one embodiment of the present invention;

FIG. 6 provides a logic flow diagram for a dividend generator, according to one embodiment of the present invention;

FIG. 7 is a logic flow chart depicting the proxy asset order processor, according to one embodiment of the present invention;

FIG. 8 is a logic flow chart illustrating an embodiment of the proxy asset trading, issuance and redemption system, according to one embodiment of the present invention;

FIG. 9 is a relational block diagram depicting a proxy asset bundle manager, according to one embodiment of the present invention;

FIG. 10 is a block diagram of one embodiment of a proxy asset system in accordance with the present invention; and

FIG. 11 is a block diagram of a portion of one embodiment of a proxy asset system having a shift control mechanism.

For the most part, and as will be apparent when referring to the figures, when an item is used unchanged in more than one figure, it is identified by the same alphanumeric reference indicator in all figures.

### DETAILED DESCRIPTION OF THE PREFERRED EMBODIMENT

The present invention is directed to a novel proxy asset system operated by a system proprietor responsible for implementing and managing a group or set of proxy assets. The system proprietor is linked to various ancillary information sources and outlets, via communications links, such as dedicated server lines or telephone connections to the internet. Thus, the system is accessible to brokers or outside investors, in a limited and pre-defined way. One connection of this embodiment is used to monitor the value of one or more indices.

The proxy asset system, in one embodiment, is implemented by a proxy asset data processor and a programmed controlled criterion for operation, with this criterion well understood by participants. The proxy asset data processor includes a proxy asset account manager and a proxy asset dividend generator. In addition, the proxy asset system preferably includes a trading, issuance and redemption system that receives and stores customer orders to buy and sell, including market orders, limit orders and possibly other varieties of order. It also executes these orders by trading existing proxy asset shares or issuing or redeeming proxy asset shares in complete sets, later defined, as needed.

In this example, the stored programming implements an account formula or an account-shifting function that defines the balances in the accounts and a distribution payout formula for each proxy asset, to be discussed here below. The pooled resources for all accounts within the system are invested in some assets, such as money market instruments, by an investment manager, or separate firm external to the system, characterized herein as the bank. The bank reports to the system proprietor the value of the pooled resources, and the system proprietor tracks the separate accounts for the proxy assets, which are claims on the pooled funds in the bank. The underlying criteria for account processing are publicly distributed to insure complete knowledge by participants. Transfers are made among cash accounts within the proxy asset system. The illustrative examples here each present a single proxy asset system, recognizing that there could be more than one such system, each operating at different institutions run by different system proprietors.

Another exemplary proxy asset system embodiment implements, at a minimum, two proxy assets for real estate in a given city for a given base year. These two proxy assets are referred to as an up proxy asset and a down proxy asset, one share of each forming what will be called a complete set (see below). The first proxy asset, the up proxy asset, has an account balance per share that is adjusted by the system proprietor according to an account formula that specifies that it contains, at regular intervals (e.g., quarterly), a balance proportional to the real estate price index for the given base year for that city. In addition, investors (“shareholders”) in that proxy asset receive a regular dividend or distribution according to a distribution payout formula that specifies a payout equal to a constant, predetermined, payout rate times the balance in the account corresponding to that share, and subject to an upper limit. The second proxy asset, the down proxy asset, has account balance per share that is set, according to its account formula, to equal the combined balances in the cash accounts for both up and down proxy asset per share minus the balance in the up proxy asset cash account per share. Its distribution payout formula defines a dividend equal to the payout rate times the balance in that account, so long as that balance is positive, and not exceeding an upper bound. The system is defined so that all dividends payouts are always feasible. By construction, the sum of the distribution payout formulas for an up share and a down share is always less than the combined increases in balances per share in the two accounts in the bank.

Accordingly, buying shares in the up proxy asset corresponds to investing in the illiquid real estate itself; the proxy asset is, however, liquid. Moreover, shares in the up proxy asset have the look and feel of an ordinary investment, since they confer on the investor a claim on the account which “backs” the proxy asset, thereby encouraging a receptive market psychology for these assets. Investments in the down proxy asset are less clearly analogous to existing investments. One might call a share in one of them analogous to a portfolio consisting of a short position in real estate and also to the margin account balance for that short position. By this interpretation, if the assets are created when the index is at 100, we may say that the margin account has an initial margin of 200%, rather than the 150% required by the Federal Reserve regulations for conventional short positions, the higher initial margin allowing for a reasonably well-functioning hedging vehicle without margin calls. If the index drifts far from a starting value of 100, then the proxy asset system creates new up and down proxy assets with an index that is 100 in a newer base year, issuing both up and down proxy assets at 100. Investors may then redeem their original proxy assets shares and purchase shares for the newer base year.

Since the down proxy asset does not involve margin calls at all and resembles an asset, it is better to regard it as a fundamentally new investment vehicle that makes it much easier for participants to hedge their risks.

In accordance with pre-defined logic and controlling system instructions, the system proprietor has two primary functions. The first is to create the proxy assets and distribute shares in these assets, like the up-down proxy assets described in the example above, in a way that allows free commercial access and payment of a market price for the proxy assets and redemption of shares. The second aspect involves, as seen in the example above, the management of an account of pooled resources for each proxy asset that is linked to the accounts of other proxy assets in the system, such that the changes in the value of an index are translated into changes in account balances and ultimately into distributions to the owners of the proxy asset shares. A third function, a trading, issuance and redemption system, is optionally integrated as a feature of the system.

The first primary function is to create the proxy assets. In some embodiments, the system provides tools for a human to identify the index to be used and the predefined account-shifting relationship among the proxy assets in a set.

In an alternative embodiment, the system includes computer logic to develop a proxy assets set that is optimal for the proprietor. In this embodiment, input is received via a graphical user interface that lets investors select indexes from a list of choices. Each potential investor is allowed to select from options indicating (1) an index in which the investor desires to take a position, (2) the side of the index they want to take, (3) the amount of leverage on the index, (4) the amount of money they want to invest, (5) the price range they would be willing to pay, (6) the length of time they want to hold such an investment, (7) the frequency of evaluation and exchange of assets, and (8) conditions for terminating the assets set. This alternative system then processes all such investor inputs and builds an account formula based on a set of selected indices for which a balance can be found among investments from interested investors. Some selection options, such as similarity and compatibility of the indexes, receive more weight than other selection options, such as amount of leverage. These other options themselves receive more weight than yet other selection options, such as frequency of evaluation.

As in the example above, each proxy asset within the proxy asset system has a pre-specified account formula that defines how much is in its account per share at each point of time. Those proxy assets whose account formulas sum identically to the combined values per share in the accounts corresponding to all the proxy assets in the set will be called a complete set of proxy assets. As long as all proxy assets are part of complete sets of proxy assets, then it is always possible for all proxy assets to be created such that the proxy asset data processor can always adhere to the account formulas defining the proxy assets' balances without running out of resources in the resources pool. (There may also be restrictions on the kinds of complete sets for which share redemptions or new share issues will be generated.) Proxy assets will be issued and redeemed by the proxy asset data processor only in complete sets, so that the account balances defined by the account formula and the distributions can always be paid in accordance with the account formula.

We can clarify what we have said above about account reevaluation, issuance and redemption in mathematical terms. Let us call Vₜ, the proxy assets set account value, or total value of all pooled resources accounts for a given base year in the bank at time t. Call Sₜ the number of shares of all proxy assets in the system. Thus, the value per share, averaging over the entire system with that base year is Vₜ/Sₜ, though individual proxy assets within the system will have different share values. The proxy asset data processor allows free issuance of new shares and redemption of existing shares at any time t at values so as not to disturb Vₜ/Sₜ. Thus, when a packet of new shares is issued at time t, if there are st shares in the packet, the total value of the packet must be VₜSₜ/Sₜ, so that after issuance there will be Sₜ+sₜ, shares and the total value after the issuance will be Vₜ+VₜSₜ/Sₜ, It follows that the value per share after issuance will be (Vₜ+VₜSₜ/Sₜ)/(Sₜ+sₜ) which equals Vₜ/Sₜ, the same as it was before the issuance. Note that, in general, the individual shares will not be issued or redeemed at price Vₜ/Sₜ, nor will the underlying cash value accounts for each share contain that amount.

The account formula for each proxy asset specifies how much its account contains per share, upon the occurrence of predetermined events, e.g. at regular intervals such as quarterly. The value of the account per share is given in terms of some measure of value of asset or income or indicator underlying the proxy assets, as well as in terms of Vₜ/Sₜ.

A complete set is a set of n shares of proxy assets, such that the sum of account formulas for the accounts per share equals nVₜ/Sₜ. Thus, so long as the shares comprise a complete set according to the formula definitions, they can be issued or redeemed together without affecting Vₜ/St. In one embodiment, issuance is automatic when a complete set is identified in a set of bids. In another embodiment, a human may intervene before a complete set is issued to satisfy the bids. In alternative embodiments, upon identification of a complete set, redemption is automatic or both are automatic or neither is automatic, in any combination.

The distribution payout formula for each proxy asset specifies how much is paid out per share each time period to owners of that proxy asset as a function of the balance in that proxy asset's cash account per share, and possibly as a function of other data, such as interest rates and the rate of inflation, or as a function of the balances in accounts that belong to the same complete set. The distribution payout formula must be specified so that dividend payments are always feasible given the balances in the cash accounts.

There is an important reason for issuing and redeeming shares only in such a way that the value per share, averaging over the entire system, is unaffected. The reason is that the account balances of individuals will thus be protected from influence by the decisions of other investors to issue or redeem.

The account for each proxy asset has several purposes. First, all proxy asset holders receive distributions proportional to the amounts in their asset value account at the predefined evaluation events or times, by a payout factor defined by the distribution payout formula. In the preferred embodiment, the same payout factor is applied to all proxy assets managed by a single proxy asset system. Second, the account balance is used by the system to determine whether offers to buy or sell can be settled by issuance of new proxy assets or redemption of old proxy assets. Third, the account balance is provided to customers as information relevant to their evaluation of the proxy assets. The account balance may be referred to as the cash value of the investment based on the value of the pool resources.

Two illustrative techniques depict the issuance and redemption of proxy assets. The first technique involves issuing complete sets of proxy assets to brokers by conventional underwriting methods, just as new shares in corporations are issued today. Brokers who buy the complete sets will then have the burden of selling off the elements of the complete sets to clients as best they can, leaving the problem of finding customers for the elements of the complete sets to the brokers. Moreover, brokers can redeem the complete sets of proxy assets by purchasing on the market the complete sets, and submitting these back to the system proprietor.

The second technique provides for an integrated trading, issuance, and redemption system implemented by the system proprietor, (possibly with the participation of an existing electronic trading system) that solves the problem of finding complete sets for the brokers, and also allows trading of existing shares. If the proxy asset shares are traded on the trading system described here, participants in the system (e.g., brokers and possibly individuals) can place orders to buy or sell proxy assets in the form of either a market order (to buy or sell at any price) or a limit order (to buy at a price at or below a given price or to sell at a price at or above a given price), and possibly other kinds of orders. They manage the buy or sell orders partly as do other existing trading systems today. In the case of limit orders, it will search for matches, sell limit orders that are at or below buy limit orders for single proxy assets, and clear them. It will also execute buy or sell orders in another way. Whenever a set of unmatched buy orders can be found that constitutes a complete set of proxy assets, at combined prices equal to or above the combined values of the accounts of the proxy assets, then the orders will be executed by creating a new complete set of proxy assets and crediting the proceeds of the sale (minus some commission) into the accounts in amounts corresponding to the balances currently in the accounts. Whenever a set of sell orders can be found that constitutes a complete set of proxy assets, at combined prices at or below the combined values of the cash accounts of the proxy assets, then the orders will be executed by redeeming a complete set of proxy assets and transferring the balances (minus some commission) in the cash accounts in amounts corresponding to the balances currently in the accounts to the sellers. When such complete sets are discovered among buy or sell orders, it means that it is feasible to execute the order by issuance and/or redemption without having any effect on the system proprietor's ability to keep asset balances at their values specified by the cash account formula, and the execution will then be done automatically. The trading, issuance, and redemption system is preferably fully automated and electronic, though it is possible that elements of the system may need to be done manually, given possible regulatory or other issues. Please see U.S. Pat. No. 4,674,044 to Kalmus, et al., relating to automated trading techniques, the contents of which are incorporated in their entirety by reference.

There is likely to be more than one way to fill buy and sell orders placed on this exchange, including various combinations of trades, issuance or redemption. In such embodiments, a rule selects the transaction set that maximizes or minimizes the price for one side of the proxy asset set, prioritizes transactions by the size of orders, clusters the orders if people are willing to wait, or alternates among these selection criteria or uses some combination of them. Any other method for prioritizing transactions known in the art may be used.

In some implementations of the trading, issuance, and redemption system, the system proprietor is not the only exchange, or even the primary exchange, on which the existing proxy assets are traded. Trades on the system may be limited to issuance and redemption, or limited to certain times, such as once a month. Additional system constraints are imposed to reflect federal and state regulations, taxation issues and issues raised by existing securities exchanges.

A separate aspect involves the creation of proxy asset bundles, which are groupings of proxy assets that may be traded as a bundle even if the individual components do not trade individually. Under this approach, the system implements the dismantling of the proxy asset bundles under select circumstances. The bundling and dismantling will be illustrated below. In some embodiments, the rules include trigger events for which termination occurs and the specifics of disbanding the proxy assets set and distributing the entirety of the resources pool. In these embodiments, trigger events include reaching a certain duration for the proxy assets set since its inception, reaching a certain percent of the pooled resources in one proxy asset or subset of proxy assets, achieving a fixed threshold value in one proxy asset or subset of proxy assets, changing the proprietorship of the proxy assets set, or changing the definition or computation of the index on which one of the proxy assets is based, or any combination of these events.

The indices used to define the proxy asset or set of proxy assets can be any measure not determined by an investor in the proxy asset or set. There is only required an investor interested in an investment that corresponds to changes in the index. Several further examples of indices an investor would want an asset to respond to in other embodiments are given below.

The indices can include a composite stock index such as the Standard and Poors (S&P) 500 index or the Dow Jones Industrial index. The indices can include any economic indicators.

In one embodiment, the composite stock index is used to define one proxy asset that tracks earnings, e.g., that strips a portion from the total growth of the index due to earnings in a quarter. Another proxy asset in the set then tracks appreciation of the underlying composite stocks in “an appreciation strip.” If an appreciation strip is computed first, the earnings are tracked with a residual between the stock price and the appreciation strip. In other embodiments, the earnings strip proxy asset can strip earnings as figured over one or more years.

In other embodiments, indices are defined that track earnings in different combinations or subcombinations of corporations or other companies. For example, in one embodiment, an index represents earnings of one or more corporations. In another embodiment, an index represents earnings in a particular time period for a plurality of corporations. In another embodiment, an index is used that represents price to earnings ratio for a corporate stock. In another embodiment, an index is based on a tracking stock for a subdivision of a company.

In one embodiment, the economic indicator is the consumer price index (CPI). Persons of fixed income may want proxy assets that track the CPI as a hedge against inflation. The CPI is a natural for an up/down proxy asset pair. In another embodiment, the index is a component of the CPI, such as energy or medical costs. An industry needing cheap energy to compete may want to hedge its position by investing in a proxy asset that increases in value as energy prices climb. The CPI components are material for multi-asset pooling, described below.

In another embodiment, the economic indicator is a balance of trade. Up/down proxy assets can pit the U.S. versus the rest of the world. Multi-asset pooling can define a set of proxy assets that track each country against the world or any pair of countries. Those investing in currencies may need such proxy assets to hedge their currency holdings in one or more currencies.

In another embodiment, lenders can hedge their positions with proxy assets that track consumer credit default rates as one of the indices. Again, this can be done with up/down proxy asset pairs or with multiple assets by country.

In another embodiment, the indices include same store sale statistics for those needing proxy assets that hedge their position in retail outlets.

In another embodiment, the indices include bid-ask spreads in one or more commodity markets. Any one market lends itself to an up/down proxy asset pair, while multiple markets can be used for multiple proxy assets. Those with seats on a commodity market may want to hedge their position with one that increases as the bid-ask spread decreases. In other embodiments, at least one index measures income flow. One such embodiment uses indices associated with the income flow of a country. Examples of such national income flows include national income, gross domestic product, proprietor's income, imports, exports and any other item from national income and product accounts (NIPA) of a country. These measures can be nominal, real, in total, or per capita.

Another embodiment uses indices associated with the income flow that is a measure of human labor. Examples of such human labor income flows include an index of occupational incomes, such as the income of doctors or lawyers or economists, or an index of wages or salaries or both accruing to certain classes of labor, or accruing to clusters of labor with similar characteristics.

Other embodiments use indices associated with consumption expenditures. Examples include an index of consumption and consumer confidence.

Still other embodiments use indices associated with other spreads, such as a spread in different types of mortgage rates and a spread in different types of interest rates, or any combination of these.

In short, any economic or macro-economic indicator in which investors are interested in establishing a position can be used as an index used in defining a proxy assets set.

### EXAMPLE I

### Up-Down Proxy Assets

Applying the above structure to a real estate example, two proxy assets are established for each city (and associated base year) to be managed by the system: one (the up proxy asset) for a long position in real estate in that city, and the other (the down proxy asset) for a short, or reciprocal position, in the city. We shall suppose that when the proxy assets for this base year were first issued in that base year, the home price index was scaled so that the index equaled 100 then, and the initial Accounts for both the up proxy asset and the down proxy assets originally contained $100. The account formula for the up proxy asset at quarterly intervals after that is just the price index:

Up Cash Account Balance Per Share End of Quarter=Home Price Index.

The cash account formula for the down proxy asset cash account balance per share, that determines its cash account balance at time t is:

Down Cash Account Balance Per Share End of Quarter=2×Total Account Balances Per Share−Home Price Index.

(In terms of the mathematics shown above, the up proxy asset account balance at the end of quarter t equals the home price index at time t, Iₜ, and the down proxy asset cash account balance equals 2Vₜ/Sₜ−Iₜ). Transfers between the accounts are made each quarter to assure that at the end of each quarter these account formulas are satisfied. Thus, if the index is 100 in the base year and is now 120, (reflecting an increase in real estate prices since the base year), then the underlying account for each up asset share has $120 in it. The account balance for one share of the down asset is just the combined investment value of the balances in a pair of up and down assets in that city minus the index. The combined investment value in the up and down accounts was $200 for two shares on the base date, when the index was 100 by definition. Today it is the accumulated investment value (in the money market fund where the resource pool is invested) since the base date, after paying out dividends according to the distribution payout formula. Thus, for example, if the combined value in the up and the down cash accounts per share is now $205, then when the index is at 120, the up share is $120 and the down account has $85 corresponding to each down asset share.

To support issuance-redemption and trade execution, the proxy asset data processor searches over the buy and sell orders to find a complete set whose total prices exceed the total value of a set. Since a complete set consists of one up proxy asset share and one down proxy asset share, then whenever an offer to buy an up proxy asset share at price P₁ and a down proxy asset share at price P₂ are found such that P₁+P₂≧2Vₜ/Sₜ both orders are executed. One new share is issued for each proxy asset and the resources pool is incremented by 2Vₜ/Sₜ. From the proceeds of the combined sale the proxy asset data processor allocates an amount equal to the value corresponding to one up share to the up account, and an amount equal to the value corresponding to one down share to the down account. Thus, after this issuance of new shares, each share has the same account balance as before, and there are now more shares outstanding. When offers to sell the shares are found at prices such that P₁+P₂≦Vₜ/Sₜ, then the shares are redeemed. When shares are redeemed, the number of shares is decreased, the resources pool is decreased by Vₜ/Sₜ times the number of redeemed shares, and an amount is deducted from each proxy asset account in proportion to the amounts already in these accounts.

Trades occur when an offer to buy one up proxy asset share at price P₁ and an offer to sell one up proxy asset share at price P2 are found by the proxy asset data processor so that P₁≦P₂. Then the order is executed without issuance or redemption, merely by selling an existing share. The same occurs for offers to buy and sell down proxy assets. In the above examples, we have neglected, for illustrative purposes only, the commission charged for the sales and also the profit accruing from these trades.

The distribution payout formula for both up and down proxy assets in this example is given by:

Dividend Per Share=r×(Amount in Own Account Per Share) if positive and if amount in own account is less than the combined value in the two accounts

=0 if Account is Negative

=r×(Combined Amount in the Two Accounts) if amount in own account is greater than the combined value where r is a payout rate defined by the proxy asset system rules. In one version, the payout rate r is a fixed number such as 2% per annum, corresponding to an estimate of the long-term real interest rate on money market accounts. (It must of course be less than 100% so that the dividend payout is always feasible, but presumably it will be much less. Preferably, it is less than the actual growth of the resources pool.) In another version, the rates r are predetermined to be a given number for the up asset and a different number, e.g., a smaller number or zero, for the down asset. The down proxy asset's cash account could have a negative value in it, in which case no dividend will be paid to its shareholders. In this case, the up proxy asset's cash account would have more than the total cash in the two accounts, in which case the dividend paid for the up proxy asset per share would just be the payout rate, r, times the total cash in the two accounts per share. The investor holding the down asset will receive no payout in this case. The market price of the down proxy asset may still be positive, since there is always the possibility that the index will drop enough to bring its balance to a positive number again.

Note that in this embodiment the market price of the up proxy asset will tend to the index, so long as the index does not differ too far from 100. In this case, investing in the up proxy asset will be a proxy for investing in the real estate itself. So long as the unobserved dividends (in the form of housing services) on the actual real estate are approximated by the distribution payout formula payout rate, then the owner of the proxy asset will be receiving the same dividends as would be received by investing in the real estate itself. So long as the proxy asset price stays close to the price index for the real estate, then investing in the proxy asset will also tend to produce essentially the same capital gains and losses as investing in real estate. However, investing in the proxy asset will not produce the identical capital gains and losses because the proxy asset market will be more liquid, allowing investors to take better advantage of predictable movements in index values.

The down proxy asset will be extremely useful to homeowners wishing to hedge the risks of their investment in their own home. As is well known, many recent declines in real estate markets have caused homeowners to lose the real equity in their homes. A single decision of a homeowner to put part of his or her investments in a down proxy asset for the city will then effectively hedge the homeowner indefinitely against such price risk. Because the down proxy asset has such a simple form, and is easily understood, it is easy for people to do this.

The system will provide continuous information about the balance in the account. This will reinforce for investors the fact that their accounts are “backed” by some real assets−the pooled resources. They will also know that if certain predefined circumstances pertain (such as termination of the system), they will automatically receive the balance in their account, further strengthening their impression that their investment has substantive value. This impression will result even though such circumstances are so defined as to be unlikely for the foreseeable future.

Bundling is applied to our up/down proxy assets to facilitate the marketing of the assets. For example, it is possible that in each city there is a demand for the down asset for that city, corresponding to the natural hedging demand for people of that city, but little or no demand for the individual up assets of individual cities, because investors all want to be diversified. The system creates and markets down assets for each of the cities, but the corresponding up proxy assets for each city is bundled for distribution as a single global up proxy asset which is a portfolio of the up proxy assets for all cities. These up assets could then later be taken apart, under defined circumstances.

In some embodiments, the initial down proxy assets are for individual zip codes or even census tracts, thereby facilitating very accurate hedging for individual homeowners. Also in some embodiments, the up proxy assets marketed are only highly aggregated bundles of the corresponding individual up proxy assets.

### EXAMPLE II

### Swap Proxy Assets

A second form of proxy asset, continuing the real estate example, is labeled here swap proxy assets. Investors wishing to swap out of the risk in their own city can buy an asset that is short in their own city and long in some other city. With such assets, they cannot adjust their overall real estate exposure (as they could with up/down proxy assets) but they can diversify their real estate exposure across cities (horizontal hedging). Adjusting the exposure to their own city can be a useful portfolio management device because many investors are not overinvested in real estate per se but are overexposed to real estate in one region. With between-city-swap proxy assets, this kind of hedging of one's risk and diversification into other cities can have the appearance of buying ordinary shares in other cities. Buying the proxy asset is like buying a share in real estate in the other city and selling exposure in a first city.

If we begin the system for N cities, then there are N2-N ordered pairs of cities, and there will be one swap proxy asset for each such pair. For the ijth pair, the account formula for the cash account for one share of swap proxy asset ij is:

Account Balance Per Share for Swap Proxy Asset ij=Average Account Value Per Share+2*(Indexᵢ−Indexⱼ−);

and for the jith pair, a swap proxy asset cash account formula is:

Account Balance Per Share for Swap Proxy Asset ji Average Account Value Per Share+2*(Indexⱼ−Indexᵢ)

Note that the average account value per share is the total balance in all accounts in the system per share, denoted Vₜ/Sₜ, above. In this example the swap proxy assets are more leveraged than in the previous up/down example, in that the indices are multiplied by two. (Another multiplier, other than two, could of course be used, to create a different amount of leverage; the number given is just for illustration.) The prices of the swap proxy assets will not have the simple interpretation of the price of the up proxy asset of the previous example, but the assets will have the offsetting advantage that they offer effective means of diversifying risk.

One way of defining the complete sets for the purpose of issuance and redemption is that all pairs of investments, one share in ij and one in ji, are complete sets. In this case, we can use the same dividend rule as was defined in the previous example of up/down proxy assets. There are other possible ways to define complete sets. A complete set could consist of a share in ij, a share in jk, and a share in ki proxy assets. These sets are circles of assets. If we defined such alternative complete sets, then we may wish to alter the distribution payout formula so that, in the case where some balances are negative, some swap proxy assets are paying no dividend. The dividends on the remaining swap proxy assets still sum to the payout rate r times the combined balances.

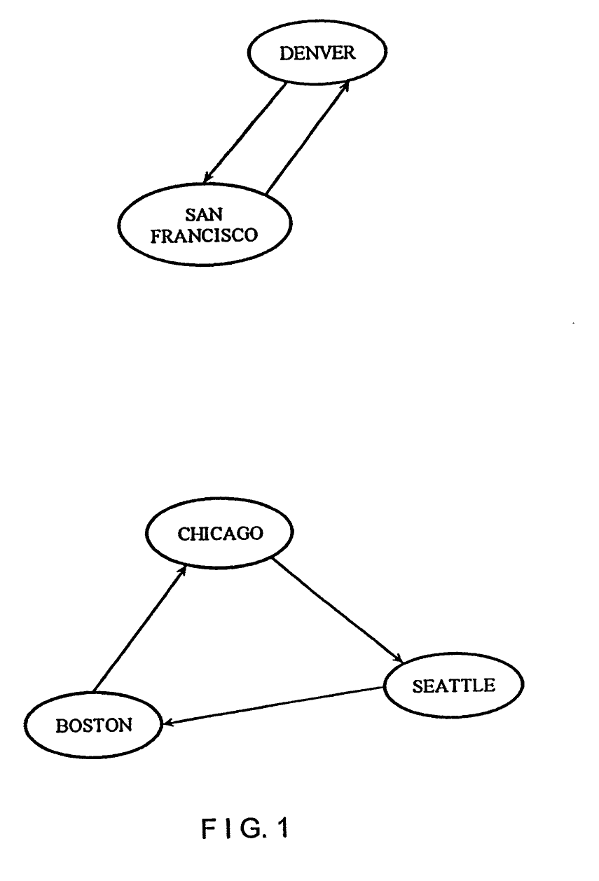

FIG. 1 shows an illustration of the kinds of closed paths (complete sets) that the swap system processor identifies among the orders to buy and sell shares. The first set, set A, is just a San Francisco-Denver swap proxy asset paired with a Denver-San Francisco swap proxy asset. The second set, set B, is a complicated closed path involving three cities and three swap proxy assets.

The proxy asset data processor applies these more complicated definitions of complete sets and searches the data to find opportunities to issue, redeem, and allow trading of proxy assets, a process much more complicated than was the case with the up/down proxy assets. For example, setting the average account balance in the system (Vₜ/Sₜ) at $105.50 dollars per share, suppose that three book windows on the trading display screen are as shown:

| | | | |
|---|---|---|---|
| Bid | Quantity | Offer | Quantity |

Boston Chicago Base 19980101

| | | | |
|---|---|---|---|
| 11015 | 100 | 12015 | 50 |
| 11014 | 50 | 12016 | 50 |
| 11013 | 50 | 12018 | 100 |
| Mar. 02, 1999 10:53 | | | |

Chicago Seattle Base 19980101

| | | | |
|---|---|---|---|
| 8593 | 50 | 8594 | 50 |
| Mar. 02, 1999 10:53 | | | |

Seattle Boston Base 19980101

| | | | |
|---|---|---|---|
| 12042 | 50 | 12043 | 50 |
| | | 12045 | 50 |
| | | 12046 | 100 |
| Mar. 02 1999 10:53 | | | |

The proxy asset system and processor would discover that a bid for 50 Boston-Chicago shares at $110.15 matches with the offer to sell 50 Boston-Chicago shares, and so this trade would automatically be executed. Thus the match shown on the hypothetical window above would not persist for more than an instant. To execute these orders, there is no need for issuance or redemption. The computer will also discover that there is a bid for Boston-Chicago for another 50 shares at $110.15, a bid for 50 Chicago-Seattle shares at $85.93, and a bid for 50 Seattle-Boston shares for $120.42. It will discover that the sum of these prices is $316.50, or three times the average cash account value per share (3 Vₜ/Sₜ), and so it automatically fills these orders by issuing the new proxy assets and allocating the proceeds from the sale into the respective cash accounts in proportion to amounts already there. Once again, these orders would not persist on the book window for more than an instant.

Note that in interfacing with an electronic trading system, such as the Globex or other system, embodiments of the invention include some modifications in the electronic trading system. For one example, traders would benefit from an embodiment which maintains more than one book window on the screen at a time, because of the interaction of orders within complete sets. For another example, traders who have asked the trading system to alert them when the price has hit a specific level, also benefit from an embodiment which alerts them in case any combination of orders for other proxy assets within the same compete set would suggest an opportunity to obtain the specified price by issuance or redemption at the specified price. This embodiment to provide such an alert relies on the embodiments which search for complete sets among the orders.

These swap proxy assets will work very well for those investors who already hold both real estate and other investments, but whose real estate investment is largely accounted for by their own homes, which are too concentrated in each city. For example, a person who owns a $400,000 home in Los Angeles and is worried about possible poor performance of real estate in Los Angeles relative to New York can invest $100,000 in proxy asset shares like those just described above, that are short in Los Angeles and long in New York. This creates a situation in which the investor is effectively invested in the Los Angeles market only in the amount of $200,000, and is effectively invested in the New York market in the amount of $200,000. The investor will thereby diversify risks equally between the two cities. The person could also invest $40,000 in each of four swaps, a New-York-Los Angeles swap proxy asset, a Miami-Los Angeles swap proxy asset, a Chicago-Los-Angeles swap proxy asset and a Denver-Los Angeles swap proxy asset. The investor will thereby diversify from an exclusive Los Angeles real estate position to a real estate position that is equally diversified across five cities.

The swap proxy assets are optionally bundled together and sold only as a group (called here a proxy asset bundle). For example, if there is much demand among residents of each city to swap their city real estate index for an average of all other cities, thereby effecting a diversified investment, then the only assets that need be marketed are the bundles of swaps that respond positively to a single city. Under certain conditions, these proxy asset bundles will provide the underlying swaps to the public which then may be disassembled later if demand appears for the individual components of the bundles.

If there is much demand among investors to invest in how well each city's real estate index will perform relative to all of the others combined, the relevant assets are the proxy asset bundles of swap proxy assets of each city versus all of the others. In this case, complete sets with only two elements would not exist; complete sets would require representation of all cities. Such structures permit investors to go long in the chosen city while requiring no one to hedge any city. Such a structure could be of value if the demand for hedging is minimal.

### EXAMPLE III

### Multi-Asset Pooling Proxy Assets

A third form of proxy asset is labeled here as multi-asset pools. This arrangement has no down securities, only up securities; the up securities for a given index function also as down securities for the others together. Here, N proxy assets, each, corresponding to an index Iat, a=1, . . . , N, at time t, swaps the one index against the remaining N-1 indices. A complete set is one of each of the N proxy assets. The account function that defines the balance per share after transfer in cash account a at time t may be given by:

$${balance}_{at} = {V}_{t} / {S}_{t} , + {I}_{at} - {\sum }_{α \neq α} {I}_{α t} / ( N - 1 ) a = 1 , … , N$$

For example, if N=2, then the assets are analogous to swaps between pairs of assets, as with the swap proxy assets described above. For another example, if N=5, there are five proxy assets, for example, one for the real estate of each of the five largest cities of the country. Note that this formula satisfies the adding-up constraint; the total value of all accounts after transfers still equals the total amount in all accounts before transfer (but, after payout, if any).

Another account formula defines the balance in the cash account a at time t with a nonlinear formula:

$${balance}_{at} = {V}_{t} / {S}_{t} \frac{{Nw}_{a} {INDEX}_{at}}{{\sum }_{α = 1}^{N} {w}_{α} {INDEX}_{at}} a = 1 , … , N$$

where the weights wa, a=1, . . . N correspond to the relative amounts outstanding of the various assets. (For example, cities with more people in them would get more weight.) A complete set is again one of each of the N proxy assets. With such a formula, the individual proxy asset accounts would never hit zero. Note that this formula also satisfies the adding-up constraint; the total value of all accounts after transfers still equals the total amount in all accounts before transfer (but, after payout, if any). The amounts in the various accounts would always correspond to the values in the various indices. Thus, there will be less of a need to issue securities with a new base year as time goes on. This multi-asset pooling proxy asset security will tend to be less volatile than the one defined by the linear formula.

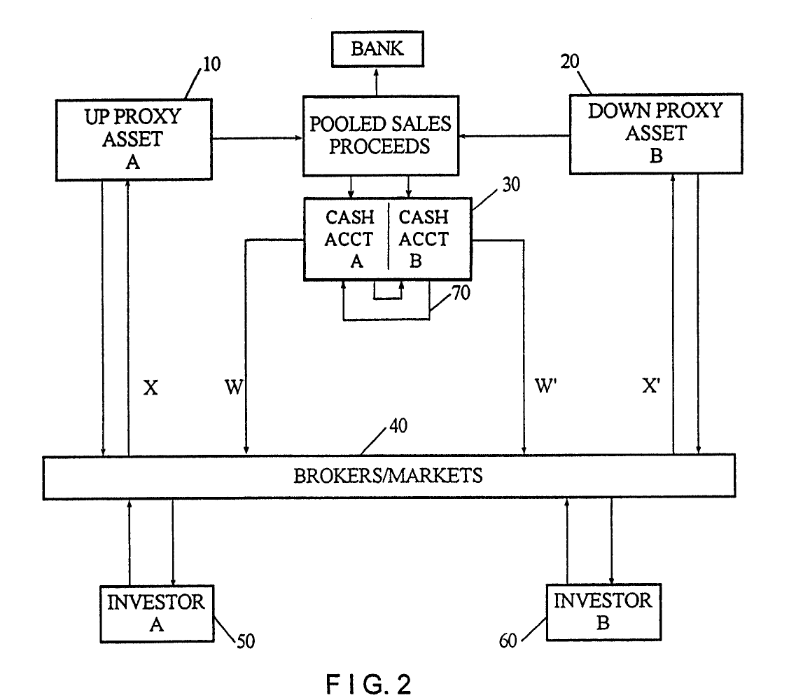

With the foregoing description in mind, attention is now directed to FIG. 2 providing a schematic block diagram of the proxy asset account manager in the up/down proxy asset version. In this exemplary arrangement, two proxy assets are created, and the two constitute a complete set.

In particular, the system proprietor issues shares of up proxy asset (A) (block 10), following orders placed in the system on behalf of investors by conventional brokerage arrangements (block 40). Similarly, the system proprietor also issues, at block 20, the down proxy assets (B), also following orders placed in the system by brokers on behalf of investors. Importantly, the shares must be issued only in complete sets, which in this example means that the number of A proxy assets issued must equal the number of B proxy assets issued. Receipts from the sale of both the up and the down securities are pooled by the system proprietor in the bank and then the individual cash accounts credited with shares of this pool, block 30, in proportions to the amounts per share already in these accounts.

As provided above, it can be recognized that no actual underlying illiquid asset has been identified or purchased by the system proprietor and, accordingly, no substantial transaction expenses have been incurred. The system operates to provide a proxy to real estate. The up proxy assets are marketed with a set of defining parameters including a link to an established index and the account, ACCT A, tied to these account balance would grow in proportion with the index. In a reciprocal manner, the down proxy asset's cash account balance would drop in value in proportion to an increase in the real estate index value. This is practically implemented by taking the actual capital from ACCT B and depositing it in ACCT A in correspondence with the changing index value, as shown at 70. ACCT A would grow and ACCT B would shrink by a like amount. As the underlying index is capable of both growth and retraction, FIG. 2 depicts capital flows in both directions.

In accordance with stored program logic, the system receives input on adjusted account balances and determines a dividend payment, W, corresponding to this new balance. An inverted relation is found between the index and the dividend stream of ACCT B, linked to the down securities. As real estate markets appreciate, funds in ACCT B are transferred out, leaving less capital for distribution generation W′, and thus a reduced distribution for the holders of the down proxy assets B even as the pooled resources grow in value. These proxy assets, however, should remain in demand at some price, because of the account value, and because of their usefulness as a hedging vehicle against a drop in real estate values.

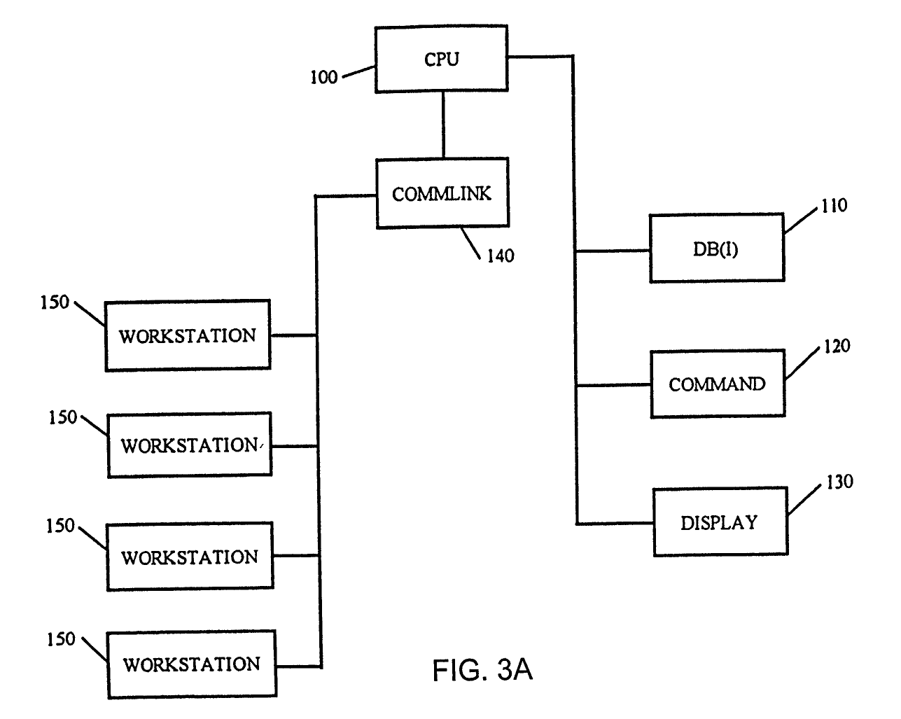

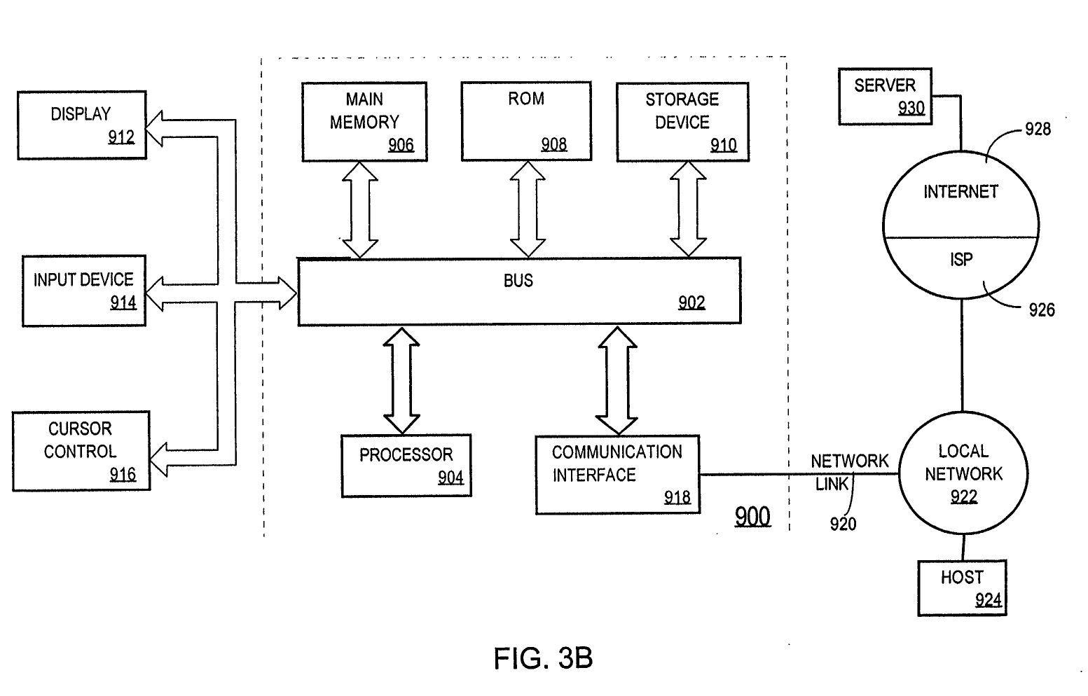

Implementation of the foregoing features is best accomplished via digital computer utilizing a uniquely defined controlling logic, wherein the computer system includes an integrated network between and among the various participants in the proxy asset security. This is depicted generally in FIG. 3A, wherein a block diagram highlights the components of a computer system useful for implementing these assets. The computer system is of conventional design, having a central processor (CPU) block 100 linked to a main database, DB(I), block 110. The main database includes archival data on the various securities, and allows proper manipulation of the underlying parameters in accordance with system logic. The database structure is outlined in detail in the database structure section below. The logic controlling system operation is stored in discrete memory block 120.

One aspect of the foregoing system involves the input of price or income indices and recording price movements and/or income changes necessary to implement changes in proxy asset accounts. Accordingly, the system includes commlink, block 140, to a network for proper controlled communication to various institutions and investors involved in the proxy asset. These participants have separate workstations, block 150, located at remote locations, but in communication with the system. It is expected that the bank, the index provider(s) and the brokers handling trades with individuals, as well as possibly the investing individuals themselves, will each communicate with the system proprietor.

The actual hardware configuration used is not particularly critical, as long as the processing power is adequate in terms of memory, accounts, periods of updating indexed values, the number of proxy assets and their respective cash account formulas and dividend payout formulas, and order execution, redemption and issuance. A network of PCs with a windows NT operating system is expected to give acceptable performance. Oracle based database engines allow substantial account coverage and expansion. The controlling logic uses a language and compiler to match that on the CPU 100. These selections will be set according to per se well known conventions in the software community.

Another embodiment of computer hardware on a network is shown in FIG. 3B. FIG. 3B is a block diagram that illustrates a computer system 900 upon which an embodiment of the invention may be implemented. Computer system 900 includes a bus 902 or other communication mechanism for communicating information, and a processor 904 coupled with bus 902 for processing information. Computer system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904. Computer system 900 further includes a read only memory (ROM) 908 or other static storage device coupled to bus 902 for storing static information and instructions for processor 904. A storage device 910, such as a magnetic disk or optical disk, is provided and coupled to bus 902 for storing information and instructions.

Computer system 900 is coupled via bus 902 to a display 912, such as a cathode ray tube (CRT), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

The invention is related to the use of computer system 900 for proxy assets. According to one embodiment of the invention, proxy assets are defined and managed by computer system 900 in response to processor 904 executing one or more sequences of one or more instructions contained in main memory 906. Such instructions may be read into main memory 906 from another computer-readable medium, such as storage device 910. Execution of the sequences of instructions contained in main memory 906 causes processor 904 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 904 for execution. Such a medium may take many forms, including but not limited to, non-volatile media, volatile media, and transmission media. Non-volatile media includes, for example, optical or magnetic disks, such as storage device 910. Volatile media includes dynamic memory, such as main memory 906. Transmission media includes coaxial cables, copper wire and fiber optics, including the wires that comprise bus 902. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 904 for execution. For example, the instructions may initially be carried on a magnetic disk of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 provides a connection through local network 922 to a host computer 924 or to data equipment operated by an Internet Service Provider (ISP) 926. ISP 926 in turn provides data communication services through the world wide packet data communication network now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are exemplary forms of carrier waves transporting the information.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918. In accordance with the invention, one such downloaded application provides for values of pooled resources as described herein.

The received code may be executed by processor 904 as it is received, and/or stored in storage device 910, or other non-volatile storage for later execution. In this manner, computer system 900 may obtain application code in the form of a carrier wave.

An alternative configuration involves, instead of the 150 workstation linked by Windows NT, an Internet web site that allows trade directly over the Internet. Use of the system would still be restricted to brokers, if that is the objective, by suitable password procedures.

Table I below shows an exemplary arrangement of the database for the proxy asset data processor. This table shows the records and fields that will be necessary for proper management under this embodiment.

TABLE 1
DATABASE STRUCTURE

Format:
Records
Fields
Shareholder Information:
Customer or Client I.D. Number:
Name or firm:
Address:
Proxy Asset or Bundle ID Numbers*:
Current Numbers of Shares or Bundles Owned in Each*:
Transaction ID Numbers*:
Transaction Information:
Transaction ID Number:
Proxy Asset or Bundle ID Number:
Buyer ID Number:
Seller ID Number:
Exchange, Issuance or Redemption:
Date and Time:
Number of Shares or Bundles:
Price per Share or Bundle:
Complete Set ID Number:
Buy and Sell Orders:
Order Number:
Customer ID Number:
Buy Order or Sell Order:
Proxy Asset ID Number or Bundle ID Number:
If Market Order: Numbers of Shares or Bundles
If Limit Order: Price and Numbers of Shares or Bundles
If Stop Order: Price and Numbers of Shares or Bundles
Order Date and Time*:
Order Expiration Date and Time: e.g. fill order until 1:00 pm 1/5/98
Pooled Cash Account Information:
Total Investable Assets Held for Cash Accounts (in Bank) (Vₜ):
Total Number of Shares Outstanding in Entire System (Sₜ):
Average Cash Account Balance per Share in System (Vₜ/Sₜ):
Complete Sets:
Set Number:
Proxy Asset or Bundle ID Numbers in Set*:
Index Information:
Index ID Number:
Update Frequency: e.g. quarterly
Date of Last Update:
Market Description: e.g. single family homes in Metro Los Angeles
Price or Income Index: e.g. price
Date*: e.g. First Quarter 1980
Index Level*: e.g. 100.00
Cash Account Formula:
Cash Account Formula ID Number:
Proxy Asset Type: Swap, Up or Down, etc.:
Cash Account Formula: e.g.,
a) for up Cash Account = index (index ID number)
b) for down Cash Account 2 × Vₜ/Sₜ, - index (index ID number)
c) for swap Cash Account Vₜ/Sₜ, + 2 × (A Index − B Index)
(index ID numbers)
Dividend Payout Formula:
Dividend Payout Formula ID Number:
Proxy Asset Type: Swap, Up or Down, etc.:
Dividend Payout Dates*:
Dividend Payout Formula: e.g.,
dividend paid per share = 0.02 × (Cash Account balance)
Proxy Asset Balance Change Information:
Proxy Asset Cash Balance Change Formula ID:
Proxy Asset ID Number:
Index ID Number*:
Cash Account Formula ID Number:
Cash-Balance Change Frequency: e.g. quarterly
Next Cash Balance Change Date:
Historical Cash Balance Changes:
Historical Cash Balance Change ID Number
Historical Cash Balance Change Date*:
Historical Cash Balance Before Change Amount*:
Historical Cash Balance Change Amount*:
Historical Cash Balance After Change Amount*:
Proxy Asset Definition:
Proxy Asset ID Number:
Proxy Asset Type: Swap, Up or Down:
Initial Cash per Share: e.g. $100.00
Base Date: e.g. January 10, 1998
Current Number of Shares Outstanding: e.g. 500,000
Current Cash Account Balance per share: e.g. $100
Dividend Frequency:
Next Dividend Due: e.g. January 10, 1998
Cash Account Formula ID Number:
Dividend Payout Formula ID Number:
Next Cash Balance Change Due: e.g. January 10, 1998
Cash Account Number:
Next Interest Deposit Due:
Issuance ID*:
Redemption ID*:
Proxy Asset Bundle Definition:
Proxy Asset Bundle ID:
Proxy Asset ID Numbers*:
Number of Shares of Each Proxy Asset in Bundle*:
Issuance History:
Proxy Asset or Bundle ID Number:
Complete Set ID Number:
Issuance ID Number:
Issuance Date:
Number of Shares:
Issuance Amount per Share:
Redemption History:
Proxy Asset or Bundle ID Number:
Complete Set ID Number:
Redemption ID Number:
Redemption Date:
Number of Shares:
Redemption Amount per Share:
*May be a multiple field

There are three primary functions of the logic command instructions. The first is to allow controlled creation of proxy assets, by defining new proxy assets from scratch, by bundling existing proxy assets together, by debundling existing proxy asset bundles, or by combining some or all of the above. The second is to transfer balances among accounts so that the account formula is satisfied by the balances. The third is to define and allocate dividends on the proxy assets. In each case, the critical controlling data must be stored in the properly configured database.

The first of these three functions is important, as success in risk management requires identifying the appropriate risk categories; such categories may be changing all the time. For example, investor demand for proxy assets in real estate may suddenly shift to a small configuration of neighborhoods that might be represented by a combination of zip-code or census-tract real estate price indices. The system is designed to allow the creation of new proxy assets as automatically as possible by a trained representative of the system proprietor operating the proxy asset data processor or even possibly by broker clients themselves. If the cost of creating new proxy assets is made very low, then many more such proxy assets should be created.

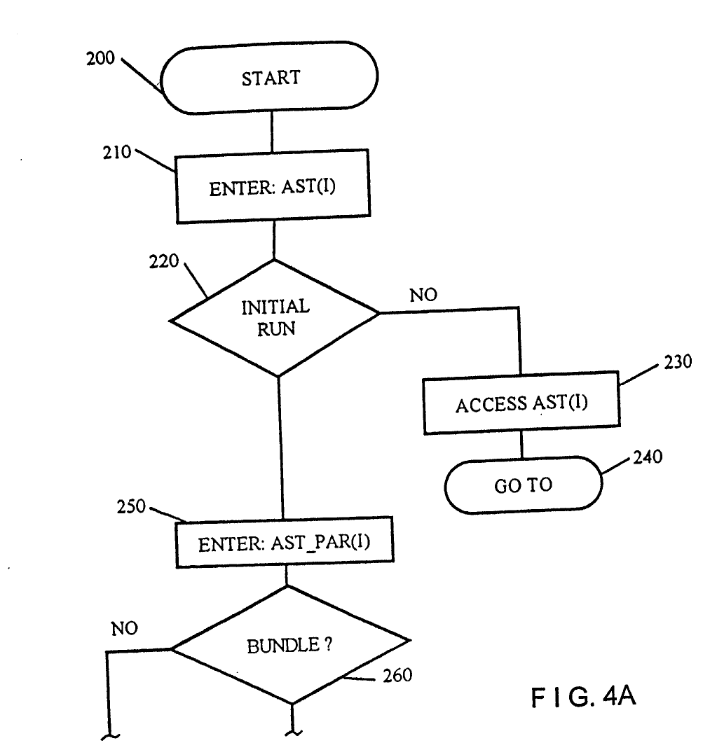

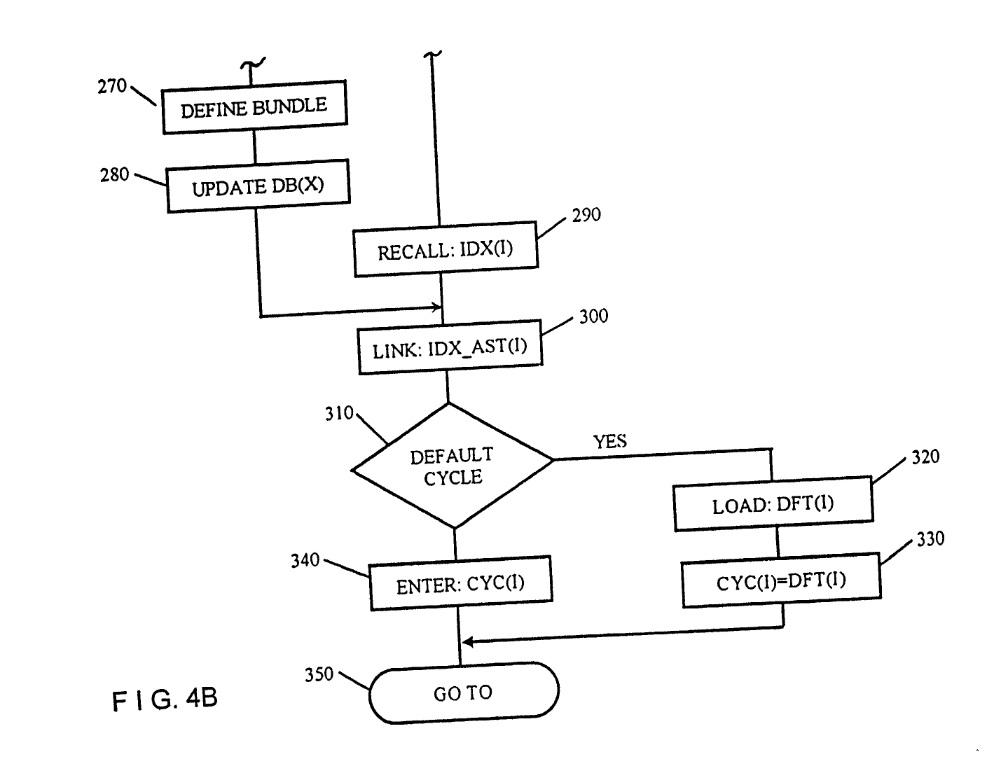

The first function is accomplished in accordance with the logic flow chart depicted in FIG. 4. Logic conceptually begins at start block 200 and continues to block 210 wherein the proxy asset under consideration AST(I) is entered by the system user. By AST(I) we mean, for the real estate example, a definition of the geographical area, identification of real estate price index, base year, cash account formula, and dividend payout formula. Since users will find it difficult to specify these, the system may provide tools, such as maps showing locations of zip codes or census tracts, and some summary statistics about the price indices for each of these.

The system first tests whether the entered proxy asset definition AST(I) is new and cannot be approximated by either existing proxy assets, an identical proxy asset already defined, by proxy assets with a slightly different base year, new bundles of existing proxy assets, components of existing proxy asset bundles, or by combinations thereof. In an initial run, test 220, the system searches over the existing proxy assets, the possibilities for new proxy asset bundles from existing proxy assets and components of existing proxy asset bundles to display the characteristics of the proxy assets that may be thus generated. The display includes information about the cash account balance that would be implied for the proxy asset under consideration. Possibly, some combination or division of proxy assets with a slightly different base year may be close enough to the proposed proxy asset. If the user signals that the entered proxy asset is not sufficiently new, if one of the possibilities put forward by the data processor is satisfactory, logic branches to block 230 and the existing records are pulled from the database for the already extant proxy asset or proxy asset bundles, with logic shifted to a separate subroutine.

A positive response to test 220 branches logic to block 250 wherein the parameters of the new proxy asset are entered into the system, and the parameters of the remaining elements of the complete set specified. In the case of simple up/down proxy assets, as illustrated in FIG. 2, the complete set can be automatically defined by the system, providing a definition of the proxy asset pair (AST_PAR(I)), both elements of which must now be created. At this point, it must be decided whether the new proxy asset pair should be defined in terms of a single index or whether the pair should be defined as a Proxy Asset Bundle in terms of a cluster of component indices. If the former, the system branches to block 290. If the latter, the system branches to block 270, where the bundle is defined, possibly by entering new indices into the system, and updating the database, block 280.

At test 310, the system queries about a default cycle for the asset adjustment period. A negative response to this allows custom entry of a controlling cycle, CYC(I), setting the time interval between adjustments for the accounts and dividends for the up/down proxy assets. The more common response to test 310 defaults the controlling interval to a system stored value, blocks 320-330. This completes the first portion of the processing with logic shifted to the next sequence, block 350.

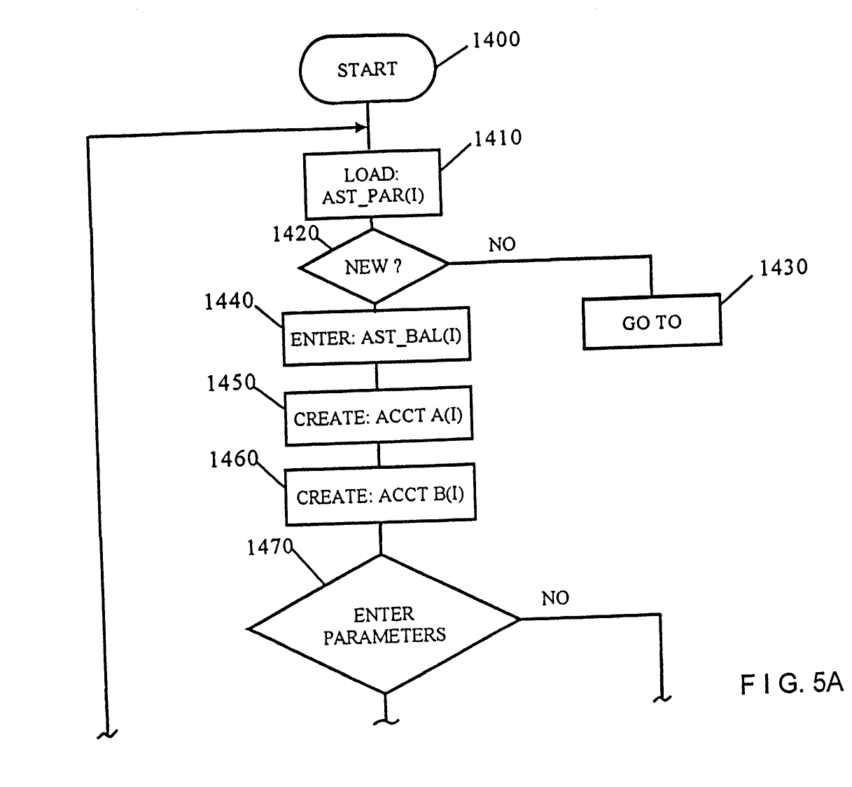

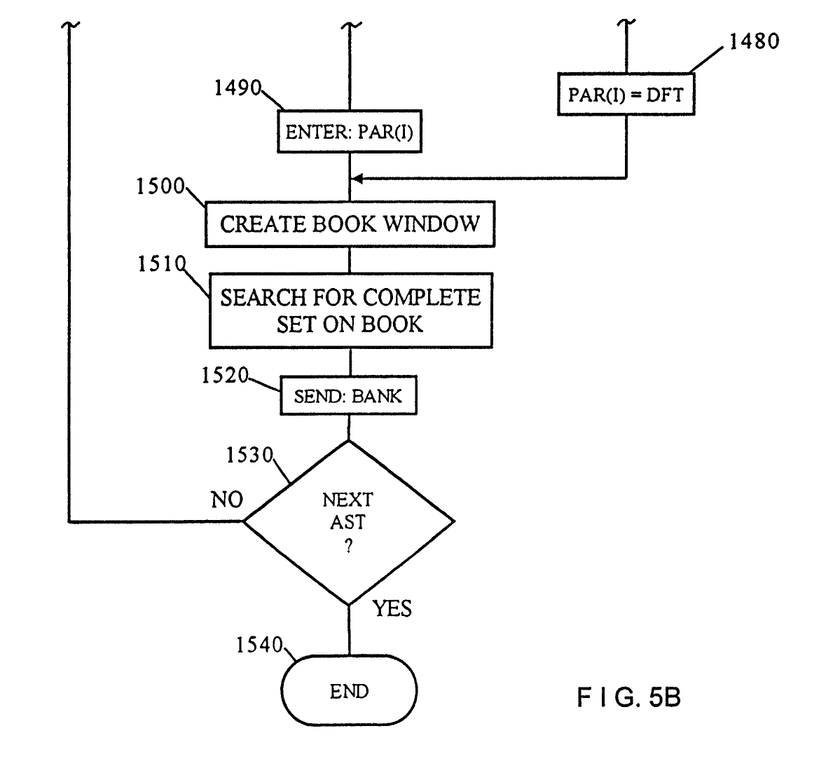

Creation of the underlying cash accounts and associated computer files and displays forming the foundation for the up/down proxy asset pair is accomplished by the logic control commands shown in FIG. 5. Beginning at start block 1400, logic first enables the entry of the pending proxy asset pair, AST_PAR(I) block 1410. The system checks whether this is a new proxy asset pair at test 1420. If new, logic continues to block 1440, wherein the cash account balance per share AST-BAL(I) is entered for both elements of the pair. These balances provide the financial backbone of the proxy assets. Implementation is made at blocks 1450-1460 setting up the two corresponding accounts ACCTA(I) and ACCTB(I): operation allows the entry of custom account parameters (“yes” to test 1470—and entry at block 1490) or entry of pre-selected default values, block 1480.

As previously described, the system includes a communication link between various participants and governing institutions. A book window is created, block 1500, for traders on the trading system, indicating, the initial defined cash account balances per share for both proxy assets in the pair, even though no shares yet exist. Orders may now be placed by customers that will appear on the book window. To create the first proxy asset share, since no shares yet exist, the trading system must first identify a complete set within the orders whose value equals (or exceeds) the combined cash account balances per share. Thereafter, the system can fill orders both by exchanging existing shares and by finding complete sets among orders. When a complete set is first created, the bank or similar repository of capital in account form must be notified with wire transfer of funds and automatic structuring of accounts particularized in advance in response to the order. During routine operation of the proxy asset system, the system proprietor will be directly responsible for rebalancing the accounts (maintained by the bank in pooled form only) within complete sets with the changing indices governing the accounts.

Returning to FIG. 5, after the database is updated with the current (and new) AST(I) information, logic queries on the next AST value (I+1) at test 1530; if another batch is ready, logic continues to the beginning and the process is repeated for the next in series.

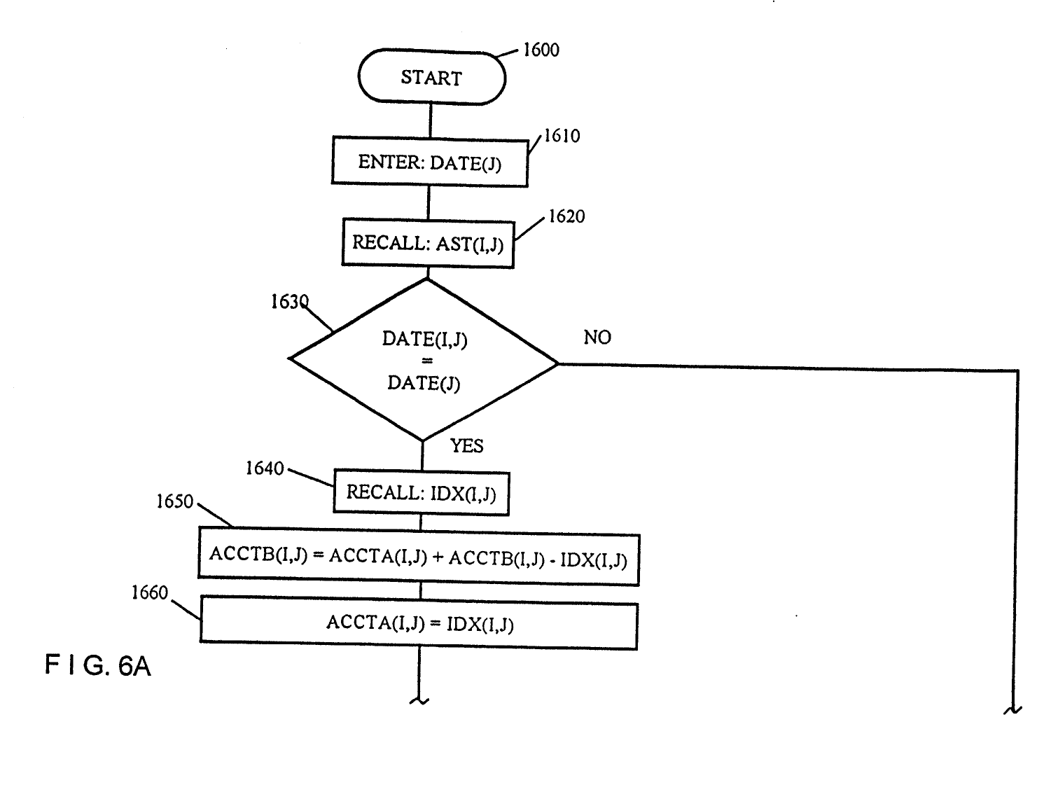

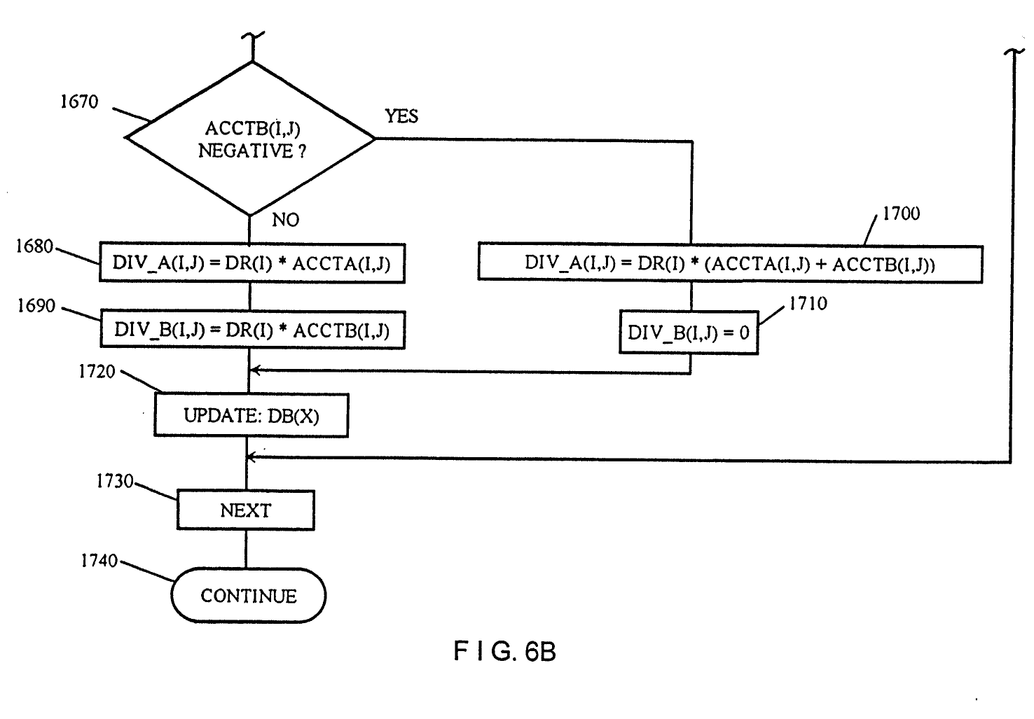

Day to day operation of the system requires analysis of a variety of time-varying inputs and selective calculation of a number of distinct variables to allow operation of the proxy asset. In FIG. 6, several of these operations and routine procedures are depicted as examples of system processing, recognizing that many other variables are tracked in like fashion.

Beginning with block 1600, logic in FIG. 6 first pulls the current date, date(J), and enters this into the process, block 1610. The current proxy asset pair file is recalled, block 1620 read, which includes the current asset balances updated for interest earned by the bank. The periodic date is compared to the present date to determine if the current date is an event date for adjusting the proxy asset accounts. A positive response to test 1630 reflects the match of dates and need to update the accounts. Accordingly, logic continues to block 1640 and the system recalls the current index value for the tracked asset, IDX(I,J). In this context, the counter variable J tracks the cycle—and thus absolute and relative time periods.

Continuing with FIG. 6, the system applies the cash account-formula to the down proxy asset, block 1650, making the balance per share equal the combined balances per share in the two accounts before the transfer minus the index, and applies the account formula to the up proxy asset, block 1660, making the balance per share just equal to the index. Note that the combined balances of the two accounts is unchanged by this transfer, so the transfer is always feasible, even though the down proxy asset cash account balance may be negative. Then the foregoing calculations are applied to calculate the appropriate dividend level per share for each proxy asset pair, using the distribution payout formula. In block 1670, the system queries whether the balance in the down proxy asset is negative. If not, the system proceeds to blocks 1680 and 1690, where each account is given a dividend at the rate DR(I). If so, then the system branches to block 1700, where the up proxy asset is defined a dividend equal to DR(I) times the combined values in the two accounts, and block 1710, where the down proxy asset is given a dividend of 0. These values are then stored in the main database, DB(x) at block 1720, and the entire process repeated for the next proxy asset under management by incrementing index variable I, block 1730.

As previously described, this embodiment of the system includes a communications link between various participants and governing institutions. These participants include a bank or similar repository of capital in account form, with wire transfer of funds and automatic structuring of accounts particularized in advance, and individual brokers or even individual investors who might place orders directly with the system. During routine operation of the proxy management system, the bank will be directly responsible for investing the pooled balances of the cash accounts, while the proxy asset system will be responsible for maintaining the cash accounts for the individual proxy assets, thereby in effect dividing up the balance in the bank among proxy asset shareholders.

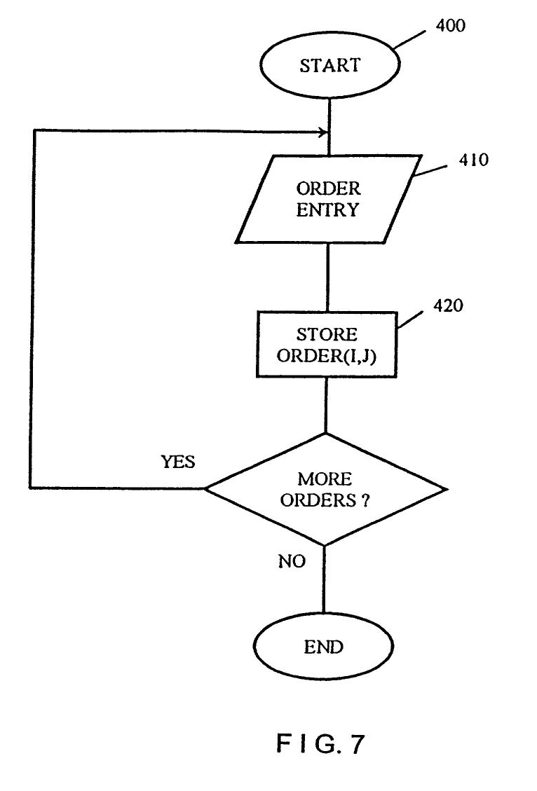

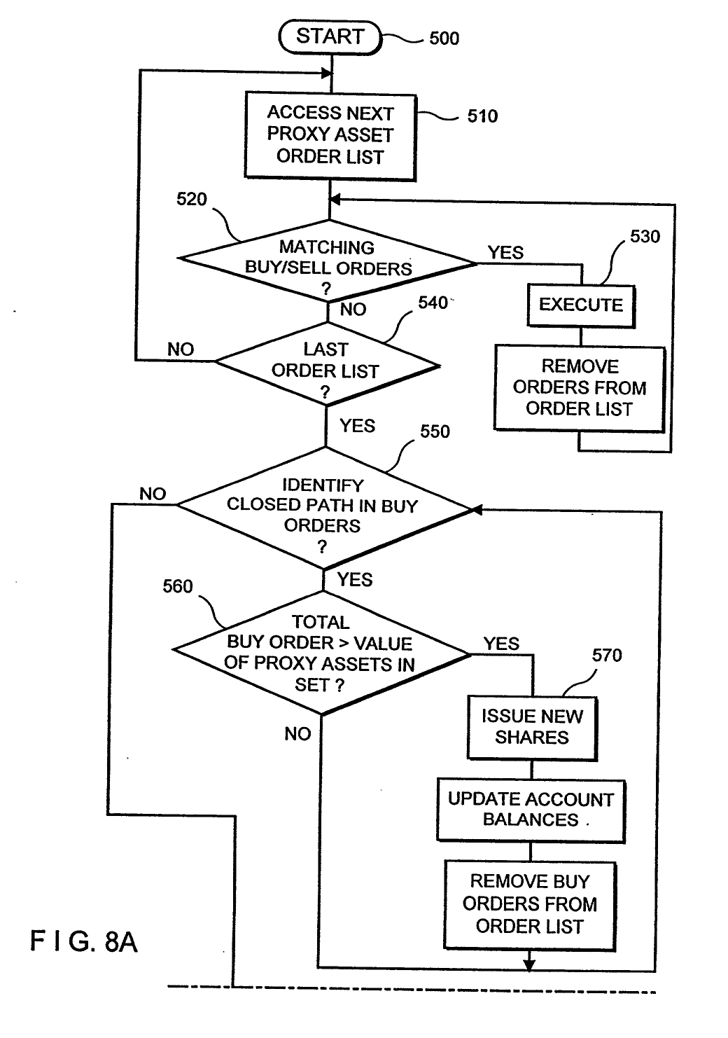

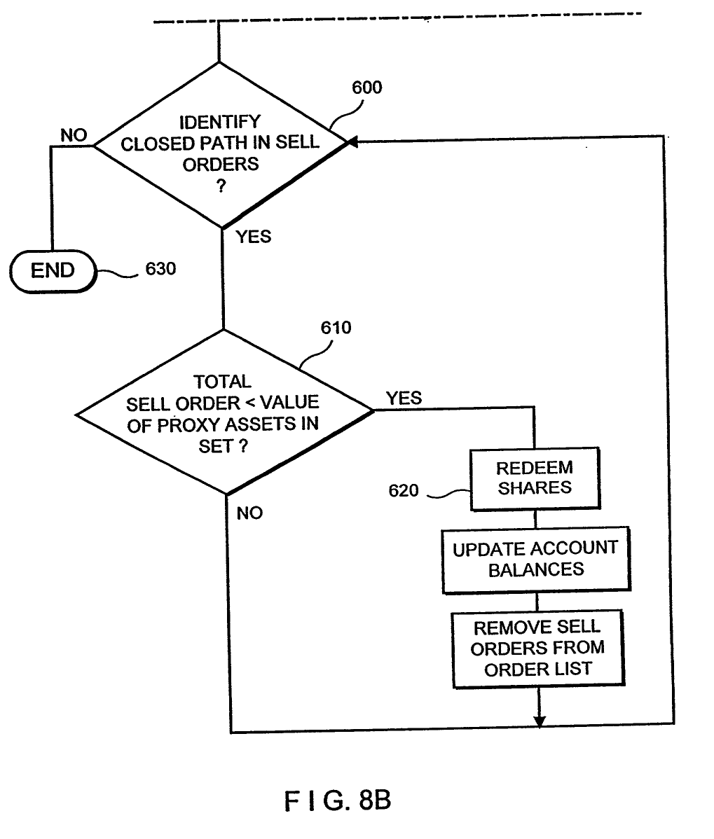

Execution of orders, by issuance and redemption or matching and clearing of buy and sell orders, for the proxy assets is accomplished by the logic and control commands detailed in FIGS. 7 and 8. FIG. 7 shows the proxy asset order processor. Beginning at start block 400 in FIG. 7, the order entry subroutine is detailed. Orders are received at block 410 from investors or brokers via workstations 150 (FIG. 3) or Internet link. Orders may consist of market orders (to buy or sell a specific number of a specific proxy asset at any price) or limit orders (to buy a specific number of proxy assets at or below a certain price or to sell a specific number of proxy assets at or above a certain price, bids and offers, hits and takes), or possibly other kinds of orders. These buy and sell orders are stored, at block 420, in a pending order list for each proxy asset in what is essentially equivalent to a book window in the trading system. In one embodiment, they are arranged in the book window with the highest bid at the top of one column and the highest offer at the top of another column, with prices in descending value below these.

With reference to FIG. 8, the proxy asset trading, issuance and redemption system begins at block 500. In a subroutine beginning at block 510, the pending order lists corresponding to each proxy asset are individually accessed and searched. At block 520, if a buy order for a proxy asset is matched with an identical sell order for that proxy asset, those shares are traded at block 530 without the issuance or redemption of any additional shares. Those orders are removed from the pending order list and processing returns to block 520 to search for additional matching orders. When no additional matches are present in the pending order list for the current proxy asset, the NO path from block 520 is followed and processing loops to the next asset in the system.

When all matching orders in the system have been processed, logic extends to block 550, whereupon the buy orders for all proxy assets in the system are together searched for a complete set or closed path. As discussed in Example I, a complete set is just an up/down pair. In Example II above, closed paths may consist of reciprocal swap proxy assets (e.g., ij and ji) or a more complicated set, such as an ij swap, a jk swap, and a ki swap (or any other path beginning and ending on the same asset). The combination of the proxy assets in the path have a total value as discussed in Example II. The sum of the buy orders in the path must equal or exceed this value. If so, test block 560 branches to a processing routine, beginning at block 570, for issuing new shares of these proxy assets, updating the accounts of the respective proxy assets in the proportion to amounts already there, then deletes these buy orders from the pending order list, before returning to loop 550 to search for additional closed paths. Alternately, if the sum of the buy orders in the identified path does not meet the total value of the path, the path identified in block 550 is rejected at test 560 and different path combinations are searched.

When no additional complete sets (closed paths) are located in subroutine 550, processing continues to a subroutine beginning at block 600, searching for closed paths of sell orders in the pending order lists of all proxy assets in the system. The sum of the sell orders is compared to the total value of the proxy assets in the identified path at block 610. If greater, the orders are executed beginning with block 620 by redeeming existing shares of these proxy assets, updating the accounts to reflect the redeemed proxy assets and deleting the sell orders from the pending order list. Processing then continues to exhaust all possible closed paths. When all closed paths are identified, the subroutine ends at block 630. Alternately, the subroutines of FIG. 8 may be performed in a different order, e.g., beginning at blocks 510, 550 or 600 as separate, and/or concurrent subroutines.

The execution of the buy and sell orders may also be connected to procedures whereby trade is suspended in unusual market situations, akin to the circuit breakers of organized exchanges. The execution of the buy and sell orders may be limited to certain classes of customers, such as registered broker dealers. The execution of the buy and sell orders may also be connected to a market surveillance system, like those at existing exchanges, to check for attempts at market manipulation or other illegal trading practices.

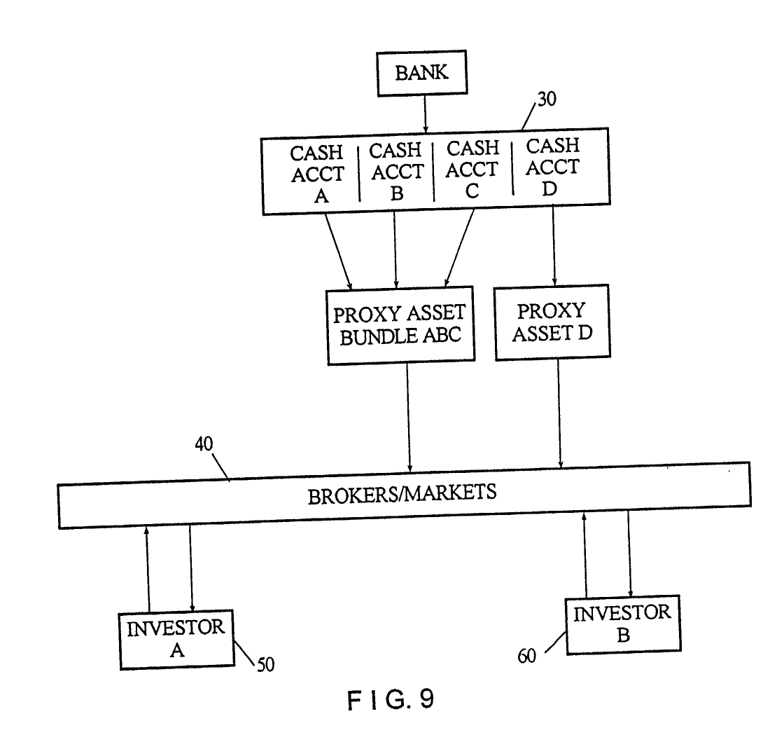

FIG. 9 is a relational block diagram depicting the proxy asset bundle manager. In this diagram, four proxy assets, proxy assets A, B, C, and D are shown for illustration. In this example, only proxy asset D is sold directly to the public. Proxy assets A, B, and C are bundled together as shown, and the bundle is sold to the public. Since the accounts for proxy assets A, B, and C are already in place, and their account formulas and distribution payout formulas already defined, people will have some idea of the effects of taking this proxy asset bundle apart at a later date. Knowing that the proxy asset bundle may be decomposed later may facilitate its marketing to the public today.

Table 2 below shows an outline of the functions of the proxy asset data processor according to one embodiment. The table gives an outline of the basic steps that this data processor must handle, on a continuing or daily basis, and the steps that are undertaken only on a less frequent basis.

TABLE 2
FUNCTIONS OF PROXY ASSET DATA PROCESSOR

```
1. Functions Ordered by System Proprietor
Add Index Data (run manually)
    Load new Index into Index Record Database
    Fill in other Fields of Index Record
Update Interest Payment (run daily)
For Each Proxy Asset:
    Is Interest Deposit Due Today?
    If Yes:
      Adjust Current Cash Balance with Interest Payment
      Fill in Next Interest Deposit Due
Pay Dividends (run daily)
For Each Proxy Asset:
    Interest Deposit Run for Today?
    If Yes:
      Dividend Payment Due Today?
        If Yes:
          Use Dividend Payout Formula to Calculate Dividend
          Pay Dividend, adjust Current Cash Account Balance
          Fill in Next Dividend Payment Due
Update Indices (run daily)
For each Index
Date for an Index Update?
    If Yes:
      Receive Index Update Into Index Record
Update Cash Account Balances Using Cash Account Formulas (run daily)
    Index, Interest and Dividend Update Performed Already for Today?
      If Yes
      For each Proxy Asset:
        Look up Cash Balance Change Formula and Necessary Indices
        Calculate Cash Account Balances Change
    Is Transfer Between Accounts due today?
        If Yes:
          Make Transfers Among Cash Accounts according to
          Cash Account Formula
Define New Swap Proxy Asset (run manually)
    Select the Two Indices to be used, Rescale to 100 on Base Date
    Select Formula Type
    Fill in Base Date and Initial Cash Per Share
    Fill in Cash Account Formula
    Fill in Dividend Payout Formula
    Make List of all Complete Sets
Define New, Up/Down Proxy Asset Pair (run manually)
    Select the Index to be Used, Rescale to 100 on Base Date
    Select Formula Type
    For both Up and Down Proxy Asset:
    Fill in Base Date and Initial Cash Per Share (same for both)
    Fill in Cash Account Formula
    Fill in Dividend Payout Formula
    Make List of All Complete Sets
2. Functions Ordered by Brokers
Process Buy Or Sell Orders (run when an order comes in)
(If for a Bundle, treat each Proxy Asset in Bundle as shown below)
Receive Transaction Request and Enter into Database
Display Order on Screen with Other Unfilled Orders
Display Historical Values of Indices
Display Cash Account Balances
Search for combinations of non-expired Buy and Sell Orders of
same Proxy Asset
Identify Matches in Limit Orders and Numbers of Shares
    If found, Execute Orders through Exchange of Existing Shares
    If None Found,
    Combine Order with other Orders of same type (e.g. Buys for same
    Proxy Asset)
    If a Bid for Proxy Asset
      Search for Complete Set Among Bids
      If Total Bid Prices in Set ≧ Total Cash Account Balances
    Then:
    Issue New Shares
    Create Transaction Records
    Create Complete Set Record
    Fill in Issuance Records
    Create Investor Records
    Fill in Historical Cash Balance Changes Record
    Update Number of Shares and Current Cash Balance in
    Proxy Asset Record
    If an Offer to Sell a Proxy Asset
    Search for Complete Sets among Offers
    If Total Offer Prices in Set ≦ Total Cash Account Balances
    Then:
      Redeem Existing Shares
      Create Transaction Records
      Create Complete Set Record
      Fill in Redemption Records
      Update Investor Records
      Fill Historical Cash Balance Changes Record
      Update Number of Shares and Current Cash Balance in
    Proxy Asset Record
Provide Information for Electronic Trading System
    Order Processing and Confirmation
    Provide Information for Book Window for Trading Screen
Provide Responses to Requests for Alerts - e. g., alert traders
when a specified price level has been reached either by a trade in
subject proxy asset or by trades in other proxy assets within
the same complete set
3. Functions ordered by Investors (Informational Web Site):
View Indices
View Outstanding Limit Orders (Book Window)
View. Composition of Bundles View Proxy Asset
    Base Date
    Indices used
    Cash Account Balance per Share
    Starting Cash Account Balance per Share
    Cash Account Balance Change History
    Dividend Payment History
    Cash Account Formula
    Dividend Payout Formula
```

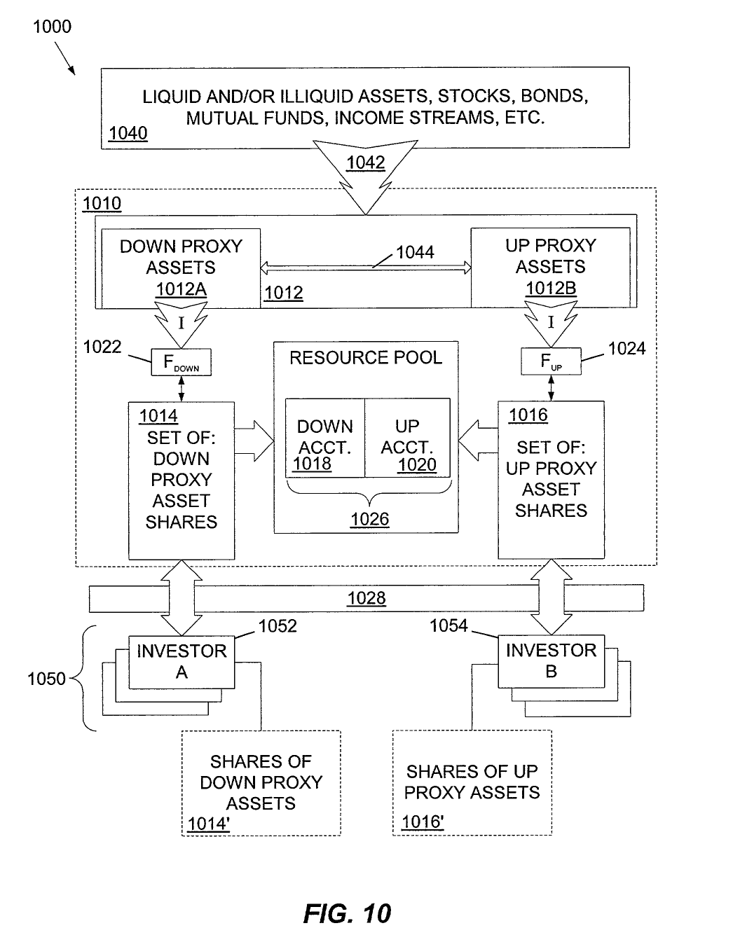

A proxy asset system in accordance with the present invention may take the form of proxy asset system 1000 of FIG. 10. In such an embodiment, a set of proxy assets 1012 is defined and related to one or more underlying assets 1040, which may include one or more of a variety of publicly or privately available liquid or illiquid assets, or some combination thereof. For example, and not by way of limitation, the underlying assets 1040 may include one or more of either publicly or privately available individual corporate stocks, groups of corporate stocks, mutual funds, and bonds, as well as streams of income (e.g., revenues or accounts receivable) from corporations, partnerships, joint ventures, sole proprietorships, individuals, trusts, estates, contracts, and so forth. The underlying assets may also include any other previously mentioned or implied types of assets. Furthermore, the underlying assets may include other proxy assets, or funds including proxy assets.

Underlying assets may be represented by one or more asset indices that are either commonly known, uniquely defined, or some combination thereof. In FIG. 10, such asset indices are represented by arrow 1042. As examples, a set of asset indices may include one or more domestic or foreign composite indices, such as an index representing S & P 500, NASDAQ, DJIA, NYSE Composite, Nikkie, and so on. An asset index may also represent a single asset, such as an individual corporate stock or a mutual fund. Additionally, the set of proxy assets 1012 is represented by a proxy asset index, denoted as “I” in FIG. 10. The value of the proxy asset index is responsive to the asset indices 1042, and is a function thereof. The proxy asset index may completely mirror the asset indices or may be a weighted function of the asset indices. In some embodiments, the various asset indices that comprise the set of asset indices may be weighted differently, i.e., by one or more leverage factors. In any event, preferably, as the values of the asset indices 1042 change so too does the value of the proxy asset index.

The set of proxy assets 1012 includes at least two subsets of proxy assets, a set of down proxy assets 1012A and a set of up proxy assets 1012B. In other embodiments, the set of proxy assets 1012 may include more than two subsets of proxy assets and the assets need not be characterized as “down” and “up”, but preferably have some type of value-based relationship, wherein a change in the proxy asset index causes different changes in the values of different defined proxy asset shares related to the different subset of proxy assets. For example, in one embodiment two subsets of down assets and three subsets of up proxy assets may be defined. In other examples, 1 subset of low risk, 1 subset of moderate risk, and 1 subset of high risk proxy assets may be defined, and so on. In such cases, each subset may offer a different risk reward to the investor. In the embodiment of FIG. 10, these different types of risk rewards are embodied in the functions (e.g., functions F_{down} 1022 and Fᵤₚ 1024 discussed below) that control the value of the corresponding proxy asset shares.

In FIG. 10, shares are offered to investors as claims on the set of proxy assets 1012. The shares may be offered publicly, privately, or some combination thereof. A set of down proxy asset shares 1014 is offered against the down proxy assets 1012A and a set of up proxy asset shares 1016 is offered against the up proxy assets 1012B. The market values of the down proxy asset shares 1014 and the up proxy asset shares 1016 are a function of the proxy asset index. Down shares and up shares may be purchased, sold, and/or valued in different manners and/or by different entities. Also, shares related to different sets of proxy assets (e.g., up shares and down shares) may be offered at the same time, or at different times. Shares for a given set of proxy assets (e.g., down shares 1014) may be issued and redeemed at different times (e.g., incrementally, periodically, etc.). Whether offered at the same time or offered at different times, generally, any proxy asset shares may be offered as a function of one or more conditions (e.g., the value of the resource pool reaching a certain threshold, the value of the proxy asset index reaching a certain threshold value, the value of the asset indices reaching a certain value, and so on).

A purchase of down proxy asset shares 1014 anticipates a fall in the proxy asset index, while a purchase of up proxy asset shares 1016 anticipates a rise in the proxy asset index. Therefore, as the value of the proxy asset index changes, so too does the value of the down proxy asset shares 1014 and the value of the up proxy asset shares 1016. A down account 1018 may be defined that represents the value of the down proxy asset shares 1014 and an up account 1020 may be defined that represents the value of the up proxy asset shares 1016. When the proxy asset index goes down, the value of down proxy asset shares is adjusted upwardly according to a down-function, e.g., function F_{down} 1022, and the value of the up shares 1016 goes down correspondingly. When the proxy asset index goes up, the value up proxy asset shares is adjusted upwardly according to an up-function, e.g., function Fᵤₚ 1024, and the value of the down shares 1014 goes down correspondingly.

The transfer of value between down proxy asset shares 1014 and up proxy asset shares 1016 is implemented as a shifting of proxy assets back and forth between the two opposed positions, i.e., between the subsets of down proxy assets 1012A and up proxy assets 1012B. This shifting is represented by arrow 1044 and is a function of the proxy asset index (I), which is a function of the asset indices 1042. Therefore, as an example, in response to an increase in the asset indices, the proxy asset index will also increase. Consequently, if the value of the change in the proxy asset index correlates to “X” proxy assets, then X proxy assets will be shifted from the pool of down proxy assets 1012A to the pool of up proxy assets 1012B. Accordingly, the value of up proxy asset shares 1016 will increase and the value of down proxy asset shares 1014 will decrease, since the total number of issued down and up proxy asset shares is unchanged. Although, as will be discussed below, for rebalancing purposes the number of shares issued may be altered.

Investors (e.g., Investor A and Investor B) purchase down proxy asset shares 1014′ and/or up proxy asset shares 1016′ and the currency used to purchase those shares is combined and represented by a resource pool 1026. For all intents and purposes, the resource pool 1026 includes, and constrains, the down account 1018 and the up account 1020. That is, regardless of the changes in the values of the up proxy asset shares and the down proxy asset shares, the resource pool 1026 constrains the value of the down account 1018 and the value of the up account 1020 such that the investor can not lose more money that the investor invested.

The constraint provided by the resource pool 1026 is a function of the way in which the currency that comprises the pool is invested, i.e., the way in which the proxy assets are collateralized. While the set of proxy assets 1012 represents liquid or illiquid assets, the proxy assets 1012 are preferably collateralized, at least in part, by relatively stable (i.e., low risk, reliable rate of return) securities, such as U.S. Treasury securities. Since these types of securities do not tend to lose value and, in fact, have predictable, though conservative, rates of return, the resource pool 1026 itself is practically not at risk of being diminished, and in fact earns interest income. As an example, proxy asset shares, generally, may be configured to pay dividends as a function of the interest earned on the Treasury securities used to collateralize the set of proxy assets 1012. In other embodiments, the set of proxy assets 1012 may be collateralized by other liquid or illiquid assets, such as stocks, mutual funds, shares of proxy assets, other types of ownership interest or rights, or some combination thereof.

In any of the foregoing embodiments, the value of the resource pool 1026 may be held substantially constant, with distributions made of any earnings on the underlying collateral, or the resource pool may be adjusted. When adjusted, the value of the resource pool may be adjusted as a function of a triggering event. The triggering event may include one or more of a plurality of events, such as a termination of a predetermined period of time, adding or deleting an index from a set of asset indices, a value variation in said set of indices (or an index therein), a change in a set of one or more economic indicators, a change in a level of risk reward, a change in the value of one or more of the underlying assets, a change in the prime lending rate, or a change in the attractiveness of proxy asset shares (e.g., up, down or both). These are, of course, merely examples and any of a number of economic events, or events having an economic impact, that may serve as a triggering event. Such triggering events may be monitored by a proxy asset computer system 1010 and the proxy asset resource pool 1026 may be automatically adjusted in response to such events by the proxy asset computer system. In other embodiments, the resource pool 1026 may be manually adjusted.

Additionally, in any of the preceding embodiments, the offering of proxy asset shares may be terminated as a function of a termination triggering event. The termination triggering event may be one or more of a variety of events, including predetermined events or events not previously determined. For example, such termination triggering events may include a termination of a predetermined period of time, a value variation in the set of asset indices 1042 (or an index therein), a change in rate of return of said proxy asset shares 1014 and 1016, a change in the level of risk reward to investors, a change in the value of the resource pool 1026, a change in one or more of the underlying assets, a change in the prime lending rate, or a change in the attractiveness of proxy asset shares (e.g., up, down, or both). When shares cease to be offered, they may be purchased from the owners of the shares with payouts, or distributions made according the then market value of the shares. In other instances, payouts or distributions may be transferred to a different investment vehicle in response to aforementioned types of triggering events, or some other triggering event. The termination events may be automatically monitored and the offering of shares automatically terminated by the proxy asset computer system 1010, or may be manually accomplished. In such cases, the payouts or distributions may be automatically or manually accomplished.

The proxy assets shares may be publicly or privately offered for sale. The shares may be purchased and sold in packages (as in pairs, for example) or independently (e.g., as in buying only down shares, for example). For example, the down proxy asset shares 1014 and the up proxy asset shares 1016 may be offered via the same channels as publicly available stocks, funds, bonds, and so on. Proxy asset shares may be offered on any of a variety of public or private, foreign or domestic exchanges. For example, shares of proxy assets could be offered on the NYSE, American Stock Exchange, or any of a number of exchanges, as will be appreciated by those skilled in the art. The proxy asset shares (e.g., down shares 1014 and up shares 1016) may be offered by any number of financial institutions 1028, such as banks, investment firms, brokers, and the like. Several entities may play different roles in creating a set of proxy assets, defining the functions by which the value of proxy asset shares are determined, managing the resource pool, brokering proxy asset shares, and so forth.

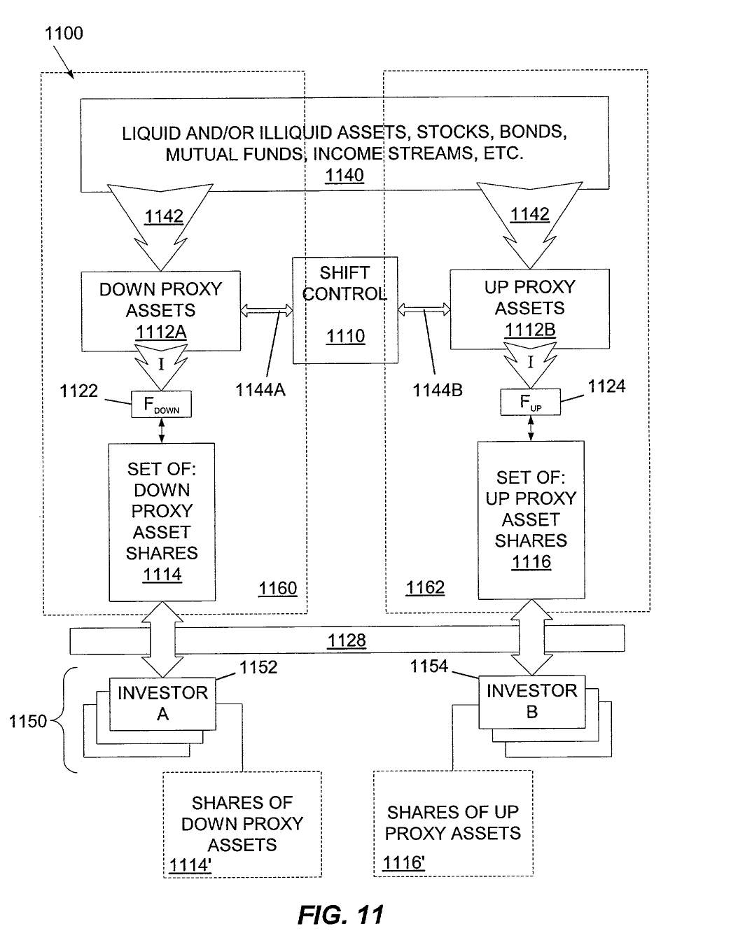

In other embodiments, such as the embodiment of FIG. 11, a proxy asset system 1100 may define a set of proxy assets comprised of two or more subsets (or pools) of proxy assets, e.g., down proxy assets 1112A and up proxy assets 1112B. Each set of proxy assets may be related to a common set of underlying assets, such as the one or more liquid and/or illiquid assets described above. In such a case, as described above, a proxy asset index I is based on an asset index 1142 (similar to asset index 1042 above) that reflects a value of the underlying assets 1140. Also, a set of down proxy asset shares 1114 represent claims on the pool of down proxy assets 1112A and a set of up proxy shares 1116 represent claims on the pool of up proxy asset shares 1112B. As described with respect to FIG. 10, the value of the down proxy asset shares is determined as a function (e.g., function F_{down} 1122) of the proxy asset index I and the value of the up proxy asset shares is determined as a function (e.g., function Fᵤₚ 1124) of the proxy asset index I. Similar to the embodiment of FIG. 10, the change in value of proxy asset shares is accomplished via the shifting of proxy assets between the pool of down proxy assets 1112A and the pool of up proxy assets 1112B, as indicated by arrow 1144.

However, in the embodiment of FIG. 11, a shift control 1110 is inserted between these two pools of proxy assets (i.e., 1112A and 1112B), which may take the form of a module of computer system 1100 (which is otherwise similar to computer system 1000). In such a case, at least one financial institution acting as or controlling the shift control 1110 enters into separate relationships (e.g., contracts) with the investors of down proxy shares and the investors of up proxy asset shares. For example, investors 1152 in down proxy asset shares 1114′ may enter into a relationship with the financial institution regarding the operations of down proxy asset shares. This relationship may be, for example, conceptualized as pertaining to elements within dashed line box 1160, wherein the relationship includes obligations pertaining to the transfer of proxy assets to and from the set of down proxy assets 1112A, depicted by double arrow 1144A. However, there are no per se obligations of the financial institution regarding transfers of proxy assets to pools of proxy assets not covered by the contract between the investor 1152 and the financial institution. Therefore, transfers of proxy assets to and from the set of up proxy assets 1112B would not be covered by the relationship between investor A 1152 and the financial institution. Investors in up proxy assets shares 1116′ have a corresponding relationship (e.g., contract) with the financial institution conceptualized as pertaining to elements within dashed line box 1162, wherein the relationship includes obligations pertaining to the transfer of proxy assets to and from the set of up proxy assets 1112B, depicted by double arrow 1144B.

In the case of FIG. 11, the financial institution may or may not also be the broker 1128, or may be one of many brokers involved in offering proxy asset shares. In various embodiments, the shift control 1110 may be used to otherwise manipulate the values of the up and down shares, by inhibiting the natural shifting of proxy assets as a function of the proxy asset index (or set of asset indices). The proxy asset shares of FIG. 11 may be offered in any of the manners previously described (e.g., on public or private foreign or domestic exchanges). Each set of proxy assets shares (e.g., down shares 1114 and up shares 1116) may be treated as being relatively independent. Down shares and up shares may be purchased, sold, and/or valued in different manners and/or by different entities. Also, shares related to different sets of proxy assets (e.g., up shares and down shares) may be offered at the same time, or at different times. Shares for a given set of proxy assets (e.g., down shares 1014) may be issued and redeemed at different times (e.g., incrementally, periodically, etc.). Whether offered at the same time or offered at different times, generally, any proxy asset shares may be offered as a function of one or more conditions (e.g., the value of the resource pool reaching a certain threshold, the value of the proxy asset index reaching a certain threshold value, the value of the asset indices reaching a certain value, and so on).

In any of the foregoing embodiments, it may be desirable to raise money for one pool of proxy assets, rather than both sets. This may be accomplished at initial public offering, or some time thereafter. For example, if down proxy asset shares cease to become an attractive investment due to, for example, an imbalance in the relationship between the down shares and the up shares, the relationship may be rebalanced at any point in time. Rebalancing may take the form of modifying the conditions under which assets get shifted between the pool of down proxy assets 1012A and down proxy assets 1012B. This may include, modifying the functions F_{down} 1022, and/or Fᵤₚ 1124, the index I, or weighting the index I, or weighting the asset indices upon which the index I is based. The rebalancing may also include redeeming proxy asset shares, modify the underlying resources or modifying that which is used to collaterlize the proxy assets. The rebalancing may also include issuing or cashing out proxy asset shares from the pool of down proxy assets 1012A, the pool of up proxy assets 1012B, or both.

In some embodiments, again to keep the proxy asset shares as competitive investments, the issuer of the proxy asset shares may, from time to time, reset the settlement price for the proxy asset shares. For example, this may be done periodically or in response to economic factors that undesirably alter the attractiveness of the proxy asset shares as an investment. This resetting may be done to redistribute the proxy assets, and consequently rebalance the resource pool 1026 between the down account 1018 and the up account 1020. It may also be done to alter the account functions 1022 and 1024. At the discretion of the issuer, the point in time when the resetting is accomplished may serve as the point in time (e.g., a new start or initial offering time) from which other account activity is related, such as determining subsequent changes in the proxy asset index or applying the relevant account formulas (e.g., functions 1022 and 1024).

Various embodiments may also include mechanisms for adjusting the offering of proxy asset shares as the investment vehicle nears stock out or reaches some other thresholds, for example, in terms of proxy asset index movement. In such a case, there may be an adjustment that keeps the price of a proxy asset share (e.g., up shares or down shares) going forward competitive in terms of yield. As an example, primary mechanisms involve either dividending out principal or rolling over the principal into a new offering. The principle exists in the resource pool generally, but may be more specifically allocated to the down account 1018 or the up account 1020, for example, and attributed to the value of the corresponding proxy asset shares. As an example, a dividend scenario would be one where the proxy asset index has moved significantly in one direction and the issuer then takes the resource pool and either just pays some of it out to the side winning (i.e., the up shares or down shares) at that point to rebalance to resource pool, takes the resource pool and uses it to buy the actual security (i.e., underlying asset) that proxy asset represents and then dividends that out proportionally. As an example, if the asset index was representative of the S&P 500, then proceeds from the resource pool 1026 would be used to by SPDRs, i.e., the S&P 500 exchange traded security, or if it were representative of an individual corporate stock, then proceeds from the resource would be used to buy shares of that corporation's stock. In another example, the proceeds from resource pool may be rolled over into proportionate shares of a similar new issue of proxy asset shares at that point with a new share (or reset) price. Otherwise, the proceeds may be rolled into other types of investment vehicles. For example, it may be predetermined that proceeds, if any, will be used to by low risk securities (e.g., Treasuries), high risk securities (e.g., high risk mutual fund), or investments having risk-reward features similar to those of the proxy asset shares. As will be appreciated by those skilled in the art, there is a wide variety of manners in which such proceeds may be disposed.

In the embodiments of FIG. 10 and FIG. 11 (or in other embodiments), the function of establishing the set of proxy assets 1012 (including the up and down proxy assets), the proxy assets index, the up and down proxy asset shares, the resource pool (including the up and down accounts) may be accomplished and managed by the proxy asset management computer system 1010. Computer system 1010 may be a single computer system or a network of distributed computer systems cooperating. Indices 1042 may serve as an input to system 1010 and the down proxy asset shares and up proxy asset shares may be managed and offered via system 1010. That is, a variety of functions may be accomplished or supported by system 1010, including issuance, redemption, buying, selling, resource pool and account management (including rebalancing), brokering of proxy asset shares, and the distribution of dividends and payouts related to the up and down proxy asset shares. System 1010 may include interfaces to third party providers of information or financial institutions, including brokers, fund managers, portfolio managers, market makers, exchanges and so forth.

As an automated system, various embodiments may allow for or facilitate on-line (e.g., Internet or Web based) trading of proxy asset shares, which may be public or private, as part of a trading system. Trading may be tightly controlled and only via privileged access (e.g., through a secure Web site). Or, trading may be available to the public generally via a public trading Web site interface, or it may be available to the public through the interface of a third party financial institution (e.g., Fidelity Investments at www.fidelity.com). In this regard, interfaces may be provided offering various types of information relevant to the proxy asset system, such as information pertaining to the proxy assets, proxy asset index, proxy asset shares, the underlying asset indices, the formulas for adjusting the value of shares as a function of the proxy asset index, and the characteristics of shifting proxy assets between the pools of up and down proxy assets. For example, information available through a computer interface (e.g., Web site) may include the name of the proxy asset (or proxy asset shares), date of issuance of the proxy asset shares, date interest was/is scheduled to be paid, approximate current yield, provisions in the particular issue for repricing, special dividends, rollovers, provision/expectation of stock out, historical performance, and projected performance. In certain embodiments, functionality (e.g., in the form of an applet) may be provided at the trading system Web site that investors could use to help them price the security or compare proxy asset shares to other investment vehicles.

Also, with respect to any of the foregoing embodiments, or other embodiments not disclosed herein, shares related to different proxy assets may be purchased, sold, and/or valued in different manners and/or by different entities. Also, shares related to different sets of proxy assets (e.g., up shares and down shares) may be offered at the same time, or at different times. Shares for a given set of proxy assets (e.g., down shares 1014) may be issued and redeemed at different times (e.g., incrementally, periodically, etc.). Whether offered at the same time or offered at different times, generally, any proxy asset shares may be offered as a function of one or more conditions (e.g., the value of the resource pool reaching a certain threshold, the value of the proxy asset index reaching a certain threshold value, the value of the asset indices reaching a certain value, and so on).

Additionally, in any of the foregoing embodiments, or substantially similar embodiments, non-proxy assets (e.g., shares in a public or privately offered, foreign or domestic corporate stock or mutual funds) may be pooled or combined with proxy assets to form a hybrid pool of assets and proxy asset shares may represent claims on the hybrid pool of assets. In such a case, the non-proxy asset shares may be altered after initial offering, i.e., shares of non-proxy assets may be bought sold in and out of the hybrid pool of assets.

Although the invention has been described in detail for the purpose of illustration, it is to be understood that such detail is solely for that purpose and that variations can be made therein by those skilled in the art without departing from the spirit and scope of the invention. Indeed, some variations may need to be made to satisfy requirements of regulators, tax authorities, existing exchanges, brokers and underwriters, requirements that may vary through time and across countries. That is, the invention may be embodied in other specific forms without departing from the spirit or central characteristics thereof. The present embodiments are therefore to be considered in all respects as illustrative and not restrictive, the scope of the invention being indicated by appending claims rather than by the foregoing description, and all changes that come within the meaning and range of equivalency of the claims are therefore intended to be embraced therein.

What is claimed is:

1. A method of providing shares in a proxy asset set, each proxy asset in said proxy asset set having a proxy asset account value, said method comprising:
A. defining a proxy asset set account value equal to the sum of the account values of all proxy assets in said proxy asset set, including constraining said proxy asset set account value by a value of a resource pool;
B. defining a first set of shares representing claims on a first subset of said proxy assets, wherein said first set of shares experience an increase in value as a function of a positive change in one or more indices according to a first formula;
C. defining a second set of shares representing claims on a second subset of proxy assets, wherein said second set of shares experience an increase in value as a function of a negative change in said one or more indices according to a second formula;
D. shifting one or more of said proxy assets between said first set of shares and said second set of shares as a function of said first and second formulas; and
E. offering said first set of shares and said second set of shares, wherein at least some shares from one or both of said first set of shares and said second set of shares may be procured, without a requirement of procuring sets of shares comprised of shares from said first set of shares and said second set of shares.

2. A method as in claim 1, wherein at least one issuer does said offering and the issuer has substantially the same number of shares from said first set of shares and said second set of shares.

3. A method as in claim 2, wherein said shifting is controlled by said issuer.

4. A method as in claim 1, wherein said offering includes offering at least some shares from said first set of shares and some shares from said second set of shares at different times.

5. A method as in claim 1, wherein said resource pool is at least partly collateralized with relatively stable securities.

6. A method as in claim 1, wherein said proxy assets represent claims on one or more foreign or domestic liquid or illiquid assets or proxy assets, such as assets chosen from a group comprising stocks, bonds, mutual funds, groups of stocks, accounts, real property, personal property, and one or more streams of income from one or more corporations, partnerships, joint ventures, sole proprietorships, individuals, trusts, estates, or contracts.

7. A method as in claim 1, wherein said proxy assets represent claims on one or more underlying assets represented by said one or more indices.

8. A method as in claim 1, wherein at least one index from said one or more indices represents a composite index chosen from a group comprising:
1) NASDAQ;
2) S & P 500;
3) Dow Jones Industrial Average;
4) NYSE Composite; and
5) Nikkei.

9. A method as in claim 1, wherein at least one index from said one or more indices is weighted.

10. A method as in claim 1, wherein said offering includes offering by a plurality of issuers.

11. A method as in claim 1, wherein said proxy asset set includes a plurality of types of proxy assets, wherein each type of proxy asset represents a claim on one or more different liquid or illiquid assets.

12. A method as in claim 1, wherein shares from said first set of shares and shares from said second set of shares may be issued and redeemed at different times.

13. A method as in claim 1, wherein shares from said first set of shares and shares from said second set of shares are offered as a function of one or more conditions, including at least one of the value of the resource pool reaching a threshold value, the value of the one or more indices reaching a threshold value, the value of at least one of the first set of shares and said second set of shares reaching a threshold value.

14. A method as in claim 1, wherein said offering includes offering shares from at least one of said first set of shares and said second set of shares on an exchange.

15. A. method as in claim 1, wherein said offering includes offering by an issuer to an investor of available shares from one of said first set of shares or said second set of shares in accordance with an agreement imposing conditions on at least one of said shifting or on a distribution to said investor as a function of a value of said available shares.

16. A method as in claim 1, further comprising:
F. terminating the offering shares from at least one of said first set of shares and said second set of shares as a function of a triggering event, wherein said triggering event is chosen from a group of events comprising:
1) a termination of a predetermined period of time;
2) a value variation in said set of indices;
3) a change in rate of return of said proxy asset shares;
4) a change in a set of one or more economic indicators;
5) a change in level of risk reward;
6) a change in the value of the resource pool; and
7) a change in the prime lending rate.

17. A method as in claim 1, further comprising:
F. adjusting the value of said resource pool as a function of a triggering event, wherein said triggering event is chosen from a group of events comprising:
1) a termination of a predetermined period of time;
2) adding or deleting an index from said set of indices;
3) a value variation in said set of indices;
4) a change in a set of one or more economic indicators;
5) a change in a level of risk reward; and
6) a change in the prime lending rate.

18. A system for providing shares in a proxy asset set, each proxy asset in said proxy asset set having a proxy asset account value, said system comprising:
A. a memory for storing a proxy asset set account value equal to the sum of the account values of all proxy assets in said proxy asset set, wherein said proxy asset set account value is constrained by a value of a resource pool;
B. at least one proxy asset share manager coupled to said memory and configured to:
1) define and store a first set of shares representing claims on a first subset of said proxy assets, wherein said first set of shares experience an increase in value as a function of a positive change in one or more indices according to a first formula;
2) define and store a second set of shares representing claims on a second subset of proxy assets, wherein said second set of shares experience an increase in value as a function of a negative change in said one or more indices according to a second formula;
C. a shifter coupled to said proxy asset manager and configured to shift one or more of said proxy assets between said first set of shares and said second set of shares as a function of said first and second formulas; and
D. a broker module coupled to said proxy asset manager and configured to offer said first set of shares and said second set of shares, wherein at least some shares from one or both of said first set of shares and said second set of shares may be procured, without a requirement of procuring sets of shares comprised of shares from said first set of shares and said second set of shares.

19. A system as in claim 18, wherein said broker module is configured to facilitate generation of offers by at least one issuer, wherein said issuer has substantially the same number of shares from said first set of shares and said second set of shares

20. A system as in claim 19, wherein said shifter is configured for control by said issuer for the shares offered by said issuer.

21. A system as in claim 18, wherein said broker module is configured for offering at least some shares from said first set of shares and some set of shares from said second set of shares at different times.

22. A system as in claim 18, wherein said resource pool is at least partly collateralized with relatively stable securities.

23. A system as in claim 18, wherein said proxy assets represent claims on one or more foreign or domestic liquid or illiquid assets or proxy assets, such as assets chosen from a group comprising stocks, bonds, mutual funds, groups of stocks, accounts, real property, personal property, and one or more streams of income from one or more corporations, partnerships, joint ventures, sole proprietorships, individuals, trusts, estates, or contracts.

24. A system as in claim 1, wherein said proxy assets represent claims on one or more underlying assets represented by said one or more indices.

25. A system as in claim 18, wherein at least one index from said one or more indices represents a composite index chosen from a group comprising:
1) NASDAQ;
2) S & P 500;
3) Dow Jones Industrial Average;
4) NYSE Composite; and
5) Nikkei.

26. A system as in claim 18, wherein at least one index from said one or more indices is weighted.

27. A system as in claim 18, wherein said broker module is configured to facilitate offers of shares by a plurality of issuers.

28. A system as in claim 18, wherein said proxy asset set includes a plurality of types of proxy assets, wherein each type of proxy asset represents a claim on one or more different liquid or illiquid assets.

29. A system as in claim 18, wherein said proxy asset manager includes a redemption module and shares from said first set of shares and shares from said second set of shares may be issued and redeemed at different times.

30. A system as in claim 18, wherein shares from said first set of shares and shares from said second set of shares are offered by said broker module as a function of one or more conditions, including at least one of the value of the resource pool reaching a threshold value, the value of the one or more indices reaching a threshold value, the value of at least one of the first set of shares and said second set of shares reaching a threshold value.

31. A system as in claim 18, wherein said broker module is configured to offer shares from at least one of said first set of shares and said second set of shares on an exchange.

32. A. system as in claim 1, wherein said broker module is configured to facilitate offering by an issuer to an investor of available shares from one of said first set of shares or said second set of shares in accordance with an agreement imposing conditions on at least one of said shifting or on a distribution to said investor as a function of a value of said available shares.

33. A system as in claim 18, further comprising:
E. a termination module configured to terminate the offering of shares from at least one of said first set of shares and said second set of shares as a function of a triggering event, wherein said triggering event is chosen from a group of events comprising:
1) a termination of a predetermined period of time;
2) a value variation in said set of indices;
3) a change in rate of return of said proxy asset shares;
4) a change in a set of one or more economic indicators;
5) a change in level of risk reward;
6) a change in the value of the resource pool; and
7) a change in the prime lending rate.

34. A system as in claim 18, wherein said proxy asset manager includes:
E. an adjustment module configured to adjust the value of said resource pool as a function of a triggering event, wherein said triggering event is chosen from a group of events comprising:
1) a termination of a predetermined period of time;
2) adding or deleting an index from said set of indices;
3) a value variation in said set of indices;
4) a change in a set of one or more economic indicators;
5) a change in a level of risk reward; and
6) a change in the prime lending rate.

35. A method for providing a proxy asset set of two or more proxy assets that responds to a set of one or more indices, each proxy asset of the proxy assets set having a proxy asset account value and a number of proxy asset shares representing equal claims on the proxy asset account value, the proxy asset set having a total number of shares equal to a sum over all the number of proxy asset shares in the proxy assets set and having a proxy assets set account value equal to a sum over all the proxy asset account values of the proxy assets set, the method comprising:
A. defining a proxy asset account value with a predetermined account formula responsive to at least one corresponding index of the set of one or more indices;
B. constraining the proxy assets set account value by a value of a resources pool; and
C. reevaluating the proxy asset account value according to the account formula upon occurrence of each event of a plurality of predetermined events,
wherein said one or more indices includes at least one of an index that represents one or more corporate stocks, mutual funds, proxy assets, or a composite index chosen from a group of indices derived from or comprising one or more of the:
1) NASDAQ;
2) S & P 500;
3) Dow Jones Industrial Average;
4) NYSE Composite; and
5) Nikkei.

36. The method of claim 35, further comprising:
D. offering at least some of said proxy assets shares for public or private trading.

37. The method of claim 35, further comprising:
D. offering at least some of said proxy assets shares on an exchange.

38. The method of claim 35, further comprising:
D. trading at least some of said proxy asset shares.

39. The method of claim 35, further comprising:
D. forming, from said proxy asset shares, a first set of shares configured to experience an increase in value as a function of a positive change in said set of indices; and
E. forming, from said proxy asset shares, a second set of shares configured to experience an increase in value as a function of a negative change in said set of indices.

40. The method of claim 39, further comprising:
F. shifting one or more of said proxy assets between said first set of shares and said second set of shares.

41. The method of claim 35, further comprising:
D. redeeming at least some of said proxy asset shares.

42. The method of claim 35, further comprising:
D. offering at least some of said proxy asset shares; and
E. terminating the offering of said proxy asset shares as a function of a triggering event, wherein said triggering event is chosen from a group of events comprising:
1) a termination of a predetermined period of time;
2) a value variation in said set of indices;
3) a change in rate of return of said proxy asset shares;
4) a change in a set of one or more economic indicators;
5) a change in level of risk reward;
6) a change in the value of the resource pool; and
7) a change in the prime lending rate.

43. The method of claim 35, further comprising:
D. adjusting the value of said resource pool as a function of a triggering event, wherein said triggering event is chosen from a group of events comprising:
1) a termination of a predetermined period of time;
2) adding or deleting an index from said set of indices;
3) a value variation in said set of indices;
4) a change in a set of one or more economic indicators;
5) a change in a level of risk reward; and
6) a change in the prime lending rate.

44. The method of claim 35, wherein the account formula includes a leverage factor, and wherein said leverage factor is applied to weight one or more of said set of indices.

45. A system for providing a proxy asset set of two or more proxy assets that respond to a set of one or more indices, each proxy asset of the proxy assets set having a proxy asset account value and a number of proxy asset shares, the proxy asset set having a total number of shares equal to a sum over the proxy assets set of the number of proxy asset shares and having a proxy assets set account value equal to a sum over the proxy assets set of the proxy asset account value, the system comprising:
A. a network;
B. a computer readable medium connected to the network, said computer readable medium storing a value of a resources pool and a number of shares of each proxy asset for each investor of a set of investors;
C. one or more bank processors connected to the network configured to compute the value of the resources pool; and
D. one or more proxy assets set processors configured for evaluating a proxy asset account value as a function of at least one corresponding index of the set of one or more indices, and for constraining the proxy assets set account value by the value of the resources pool,
wherein said one or more indices includes at least one of an index that represents one or more corporate stocks, mutual funds, proxy assets, or a composite index chosen from a group of indices derived from or comprising one or more of the:
1) NASDAQ;
2) S & P 500;
3) Dow Jones Industrial Average;
4) NYSE Composite; and
5) Nikkei.

46. The system of claim 45, wherein said proxy assets set processor is further configured to offer at least some of said proxy assets shares for private trading.

47. The system of claim 45, wherein said proxy assets set processor is further configured to offer at least some of said proxy assets shares for public trading.

48. The system of claim 45, wherein said proxy assets set processor is further configured to trade at least some of said proxy asset shares.

49. The system of claim 45, wherein said proxy assets set processor is further configured to:
1) form, from said proxy asset shares, a first set of shares configured to experience an increases in value as a function of a positive change in said set of indices; and
2) form, from said proxy asset shares, a second set of shares configured to experience an increase in value as a function of a negative change in said set of indices.

50. The system of claim 49, wherein said proxy assets processor is further configured to shift one or more of said proxy assets between said first set of shares and said second set of shares.

51. The system of claim 45, wherein said proxy assets set processor is further configured to redeem at least some of said proxy asset shares.

52. The system of claim 45, wherein said proxy assets set processor is further configured to:
offer at least some of said proxy asset shares; and
terminate said offer of said proxy asset shares as a function of a triggering event, wherein said triggering event is chosen from a group of events comprising:
1) a termination of a predetermined period of time;
2) a value variation in said set of indices;
3) a change in rate of return of said proxy asset shares;
4) a change in a set of one or more economic indicators;
5) a change in level of risk reward;
6) a change in the value of the resource pool; and
7) a change in the prime lending rate.

53. The system of claim 45, wherein said proxy assets set processor is further configured to adjust the value of said resource pool as a function of a triggering event, wherein said triggering event is chosen from a group of events comprising:
1) a termination of a predetermined period of time;
2) adding or deleting an index from said set of indices;
3) a value variation in said set of indices;
4) a change in a set of one or more economic indicators;
5) a change in a level of risk reward; and
6) a change in the prime lending rate.

54. The system of claim 45, wherein the account formula includes a leverage factor, and wherein said leverage factor is applied to weight one or more of said set of indices.
